(19) United States
(12) Patent Application Publication
(10) Pub. No.: US 2019/0034985 A1
(43) Pub. Date: Jan. 31, 2019

(54) SYSTEM AND METHOD FOR VIDEO PROVISIONING AND MANAGEMENT FOR ECOMMERCE SITES

(71) Applicant: CRITEEK COMMUNICATIONS, INC., New York, NY (US)

(72) Inventors: Scott RANDALL, New York, NY (US); Rahul KHOSLA, New York, NY (US)

(73) Assignee: CRITEEK COMMUNICATIONS, INC.

(21) Appl. No.: 16/044,152

(22) Filed: Jul. 24, 2018

Related U.S. Application Data
(60) Provisional application No. 62/537,539, filed on Jul. 27, 2017.

(51) Int. Cl. G06Q 30/02; G06Q 50/00; G06Q 30/06

(52) U.S. Cl. CPC G06Q 30/0282; G06Q 30/0631; G06Q 50/01

(57) ABSTRACT

A system or method for providing user generated video reviews to an ecommerce website, comprising a user computational device for operating a user interface, such that said user interface receives the video; a server, comprising a video uploader for receiving a user generated video review from said user interface, a moderator module for moderating the uploaded video, and a formatter for formatting the video; and an ecommerce computational device, comprising a dashboard for managing the uploaded video and a connector for connecting to the ecommerce website; wherein if the uploaded video is accepted by said moderator module, the uploaded video is then formatted by said formatter, and posted to the ecommerce website through said connector.

### FIELD OF THE INVENTION

The present invention, in at least some embodiments, is of a system and method for video provisioning and management for ecommerce sites, and in particular, to such a system and method for gathering user generated videos, such as video reviews, from multiple sources, managing and/or distribution.

### BACKGROUND OF THE INVENTION

Embedding video in websites, such as ecommerce sites, is well known. For example, an ecommerce site could choose to embed video that discusses the merits of various products.

User generated video is also quite common. For example, users currently create their own videos which they share on Facebook, YouTube and other social media sites. Users who are also shoppers on ecommerce sites may choose to post video reviews of products on such social media sites.

U.S. Pat. No. 8,615,474 describes how to receive and handle user generated video that reviews a product. The reviews may be received from a kiosk for example. These reviews are either displayed through an aggregate video review site or alternatively may be published to a social networking site.

### BRIEF SUMMARY OF THE INVENTION

The background art does not teach or describe a system or method for providing user generated video reviews to an ecommerce website. The background art does not teach or describe a system or method for obtaining such user generated video reviews through provisioning from social networks and/or from users' smart phones, tablet computers, laptop computers or other devices. The background art also does not teach or describe such a system or method for formatting such videos for optimal transmission and display on multiple domains and networks. The background art also does not teach or describe such a system or method for syndicating such videos between partner sites, multiple domains and networks.

The present invention, in at least some embodiments, overcomes these drawbacks of the background art by providing a system and method for providing user generated videos, such as video reviews, to a websites, apps or digital networks. Preferably, the videos are moderated and are also optimally formatted before being posted to the ecommerce website and optimally to multiple domains and networks.

By “video review” it is optionally meant any type of video that relates to a product, service, location, event, and so forth, including but not limited to social videos, client employee videos and influencer videos and testimonial videos. By “client employee” it is meant an employee of the ecommerce entity.

The terms “ecommerce website”, “ecommerce entity” and “ecommerce distribution-destination” are used interchangeably to refer to a company or organization owning or deploying an ecommerce platform, which may optionally be provided through a website, app, specialized software or any other suitable technology.

According to at least some embodiments, appropriate product related videos are also optionally retrieved from third party sites, such as social media channels or networks and/or partner sites. These retrieved videos are then preferably moderated and formatted for optimal transmission and/or display before being posted to the ecommerce site. Optionally and preferably, such formatting supports optimal display on multiple domains and networks.

Optionally, such videos may be exchanged between partners or distribution networks that are connected to the ecommerce site.

Preferably, one or more preferences of a viewing user, such as of a shopper on the ecommerce site for example, are determined in order for the ecommerce site to display the most relevant videos to that viewing user. For example, past behavior may optionally be used to determine which video(s) are likely to be relevant. Such past behavior may optionally be analyzed from past behavior of the viewing user, the global viewing population and/or a demographically relevant population. As a non-limiting example, past behavior could relate to previous videos watched or liked, previous products purchased, and the like.

It should be noted that U.S. Pat. No. 8,615,474 does not include any of these features, nor any other desirable feature described herein, including but not limited to, analytics, conversion tracking, or marketing automation.

Although the system and method as described herein are applicable for ecommerce sites, their applicability is not limited to ecommerce sites. For example and without limitation, the system and method, in various embodiments, may also be applied to other types of sites, including without limitation influencer sites, in which users try different products and then share their reactions. Another non-limiting example of such a site relates to expert reviewers, who provide input with regard to various products and services according to their area of expertise. Yet another non-limiting example of such a site relates to ambassador reviewers, who provide input with regard to various products according to their knowledge of that area, including for example with regard to real estate. All of these various types of sites may be collectively termed herein “reviewer sites”, and may be considered to fall within the bounds of the present invention as described herein.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computing device”, a “computer”, or “mobile device”, it should be noted that optionally any device featuring a data processor and the ability to execute one or more instructions may be described as a computer, including but not limited to any type of personal computer (PC), a server, a distributed server, a virtual server, a cloud computing platform, a cellular telephone, an IP telephone, a smartphone, or a PDA (personal digital assistant). Any two or more of such devices in communication with each other may optionally comprise a “network” or a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIG. 1A shows a non-limiting exemplary system for ingesting, processing, and distributing video, according to at least some embodiments of the present invention;

FIG. 1B shows a non-limiting exemplary system, according to at least some embodiments;

FIG. 1C shows a non-limiting exemplary process for ingestion;

FIG. 2A shows an exemplary social media ingestion process;

FIG. 2B relates to a non-limiting ingestion process for ingesting video from an ecommerce site;

FIG. 2C relates to an exemplary ingestion method for ingesting video from the ecommerce video portal;

FIG. 3 relates to a non-limiting exemplary process for processing the video;

FIG. 4A shows that optionally sandbox domain testing is performed in an exemplary process;

FIG. 4B is an exemplary process for creating and modifying the widget, which allows the ecommerce site to ingest videos, display the videos and receive videos from other sites through this particular widget;

FIG. 4C shows that the dynamic and social widget is installed in an exemplary process;

FIG. 4D relates to a non-limiting, exemplary method for manipulation and customization of video ingestion and display through an API (application programming interface);

FIG. 5A relates to an exemplary method for recording of video or uploading of pre-recorded video in the widget;

FIG. 5B relates to an exemplary process for actually viewing the video in the widget;

FIG. 5C relates to an exemplary process for determining the order in which videos are displayed in the widget based on shopper-user data collected by the platform;

FIG. 5D relates to an exemplary process for shopper social sharing;

FIG. 5E shows a non-limiting, exemplary flow for saving data through an API by the ecommerce site;

FIG. 6A relates to a non-limiting exemplary process for moderation;

FIG. 6B shows a non-limiting, exemplary process for second-level client-user moderation;

FIG. 6c shows a non-limiting method for analytics;

FIG. 6d relates to a non-limiting, exemplary process for conversion tracking;

FIG. 6e relates to an exemplary promotions process for executing shopper-user promotions to encourage shopper-users to create videos;

FIG. 6f relates to a non-limiting, exemplary process for creating or otherwise determining a product pool;

FIG. 6g relates to a non-limiting, exemplary process for email marketing automation to encourage shopper-users to create videos;

FIG. 7 relates to a non-limiting, exemplary process for a video reviewer to sign up for the product pool;

FIG. 8a relates to an exemplary, non-limiting process for providing a review;

FIG. 8b shows a non-limiting, exemplary process which relates to recording through the widget itself as opposed to uploading;

FIG. 8c relates to a non-limiting, exemplary process for uploading as opposed to recording;

FIG. 8D relates to a similar non-limiting, exemplary process for uploading, but with special social widget options, for increasing sharing possibilities;

FIG. 8e relates to a non-limiting process to assist a shopper-user who may want to view videos;

FIG. 8f relates to a non-limiting, exemplary process for sharing various videos from a widget;

FIG. 8G relates to an additional exemplary process for showing the user multiple videos;

FIG. 8H relates to an exemplary method with a different type of layout for video display;

FIG. 9a relates to a non-limiting, exemplary method for video distribution;

FIG. 9b is a non-limiting, exemplary method for distribution of video to an aggregate ecommerce-video platform;

FIG. 9c relates to a non-limiting, exemplary method for distribution syndication;

FIG. 10a shows a non-limiting, exemplary method for client social publishing; and

FIG. 10b shows a non-limiting, exemplary method for distribution through ad networks, mobile apps, shopping bots and OTT networks.

### DESCRIPTION OF AT LEAST SOME EMBODIMENTS

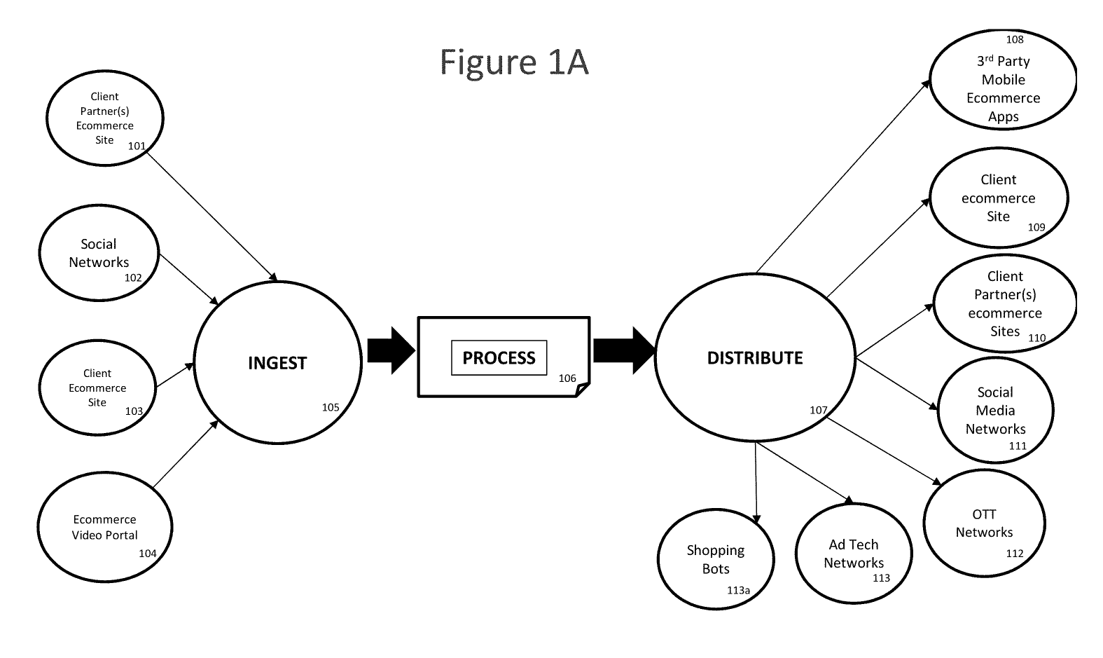

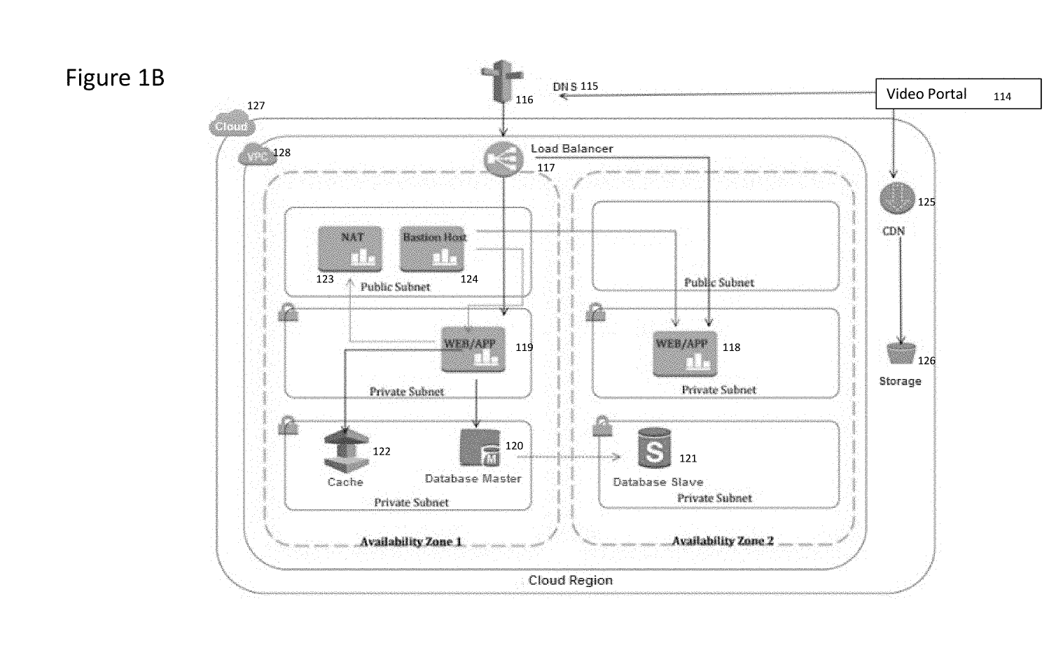

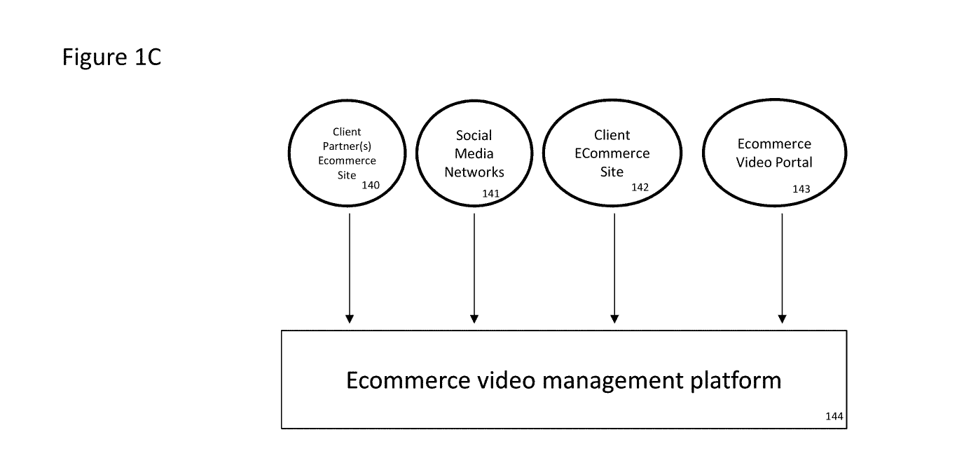

Turning now to FIG. 1A, there is shown a non-limiting exemplary system for ingesting, processing, and distributing video, according to at least some embodiments of the present invention.

The process begins with ingesting video from a plurality of sources. These sources may actually include, but are not limited to, client partner ecommerce sites 101, social networks 102, client ecommerce site 103, or an ecommerce video portal 104. All of these sources of video then feed video into the ingestion process 105. Upon ingestion, the video is processed through a video process 106, and the processed video is then digitally distributed through distribution process 107. The targets of such distribution may actually include, but are not limited to, third party mobile ecommerce apps 108, a client ecommerce site 109, client partner ecommerce sites 110, social media networks 111, OTT networks 112, shopping bots 113a and ad networks 113. Optionally digital in-store retail networks may be included (not shown). In broadcasting, over-the-top content (OTT) is audio, video, and other media content delivered over the Internet without the involvement of a multiple-system operator (MSO) in the control or distribution of the content.

FIG. 1B shows a non-limiting exemplary system, according to at least some embodiments. As shown, the system features a video portal 114, connected to a DNS (domain name server) 115 for enabling relative address location of the videos. DNS 115 is connected to a component 116, which supports distribution of the videos through a load balancer 117, within an overall cloud system. Load balancer 117 is connected to a private subnet 118, for example for supporting an ecommerce website as described herein. Load balancer 117 is connected to another private subnet 119, for example for supporting a web app, such as the dashboard for example. Such a web app may in turn receive outside input from a public subnet, such as for example a NAT (network address translation) 123 and a Bastion Host 124 (to permit access to the public subnet, for example with SSH or RDP).

The web app may also optionally be in communication with a cache 122 and a database master 120, for storing meta-data and other information related to the functioning of the dashboard. Optionally database master 120 controls a database slave 121, to avoid overload and/or for backup purposes.

Video portal 114 is also connected to a CDN 125, which can place videos in a storage 126 for later retrieval.

Optionally these components are kept within a cloud 127 as shown or a VPC (virtual private cloud) 128 for example.

FIG. 1C shows a non-limiting exemplary process for ingestion, that is to say receiving videos from a plurality of sources. The videos are received from sources such as client partner ecommerce sites 140, social media networks 141, client ecommerce site 142, and an ecommerce video portal 143.

Ecommerce video portal 143 optionally operates as an end-user portal for collecting and displaying video product reviews in aggregate, which could optionally also be used for distributing products to qualified reviewers. Client ecommerce site 142 is preferably implemented as an online store front for selling products. Client Partner ecommerce sites 140 may optionally differ in implementation according to the type of commercial partner. For brands, the partner ecommerce sites would be online store fronts of retailers who carry their products. For retailers, the partner ecommerce sites would be websites of the brands that supply them with products. Optionally both types of partners could exchange review videos with each other, for example through a system dashboard as described in greater detail below.

All of this information is preferably fed into an ecommerce video management platform 144.

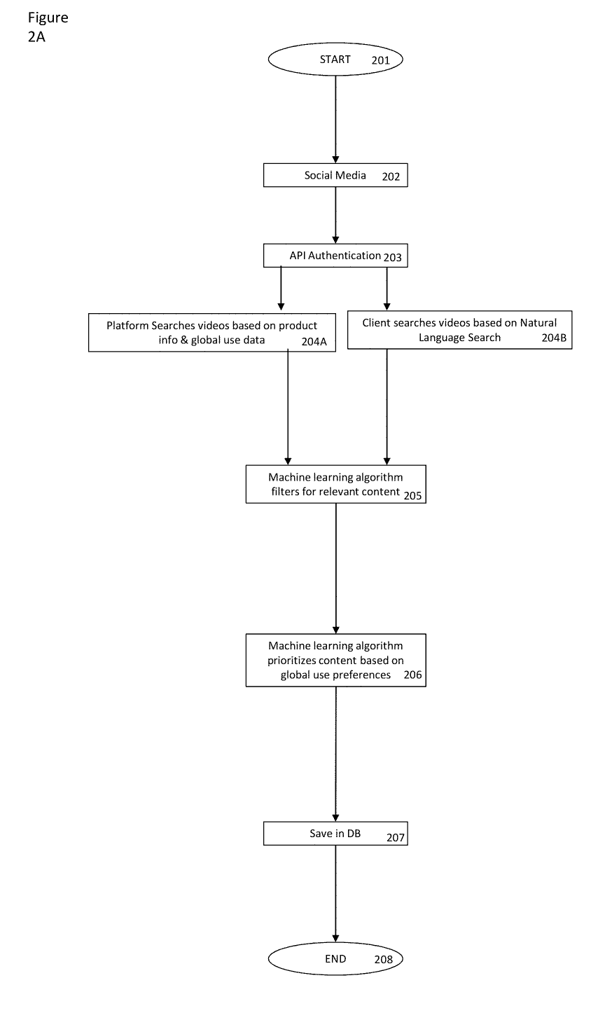

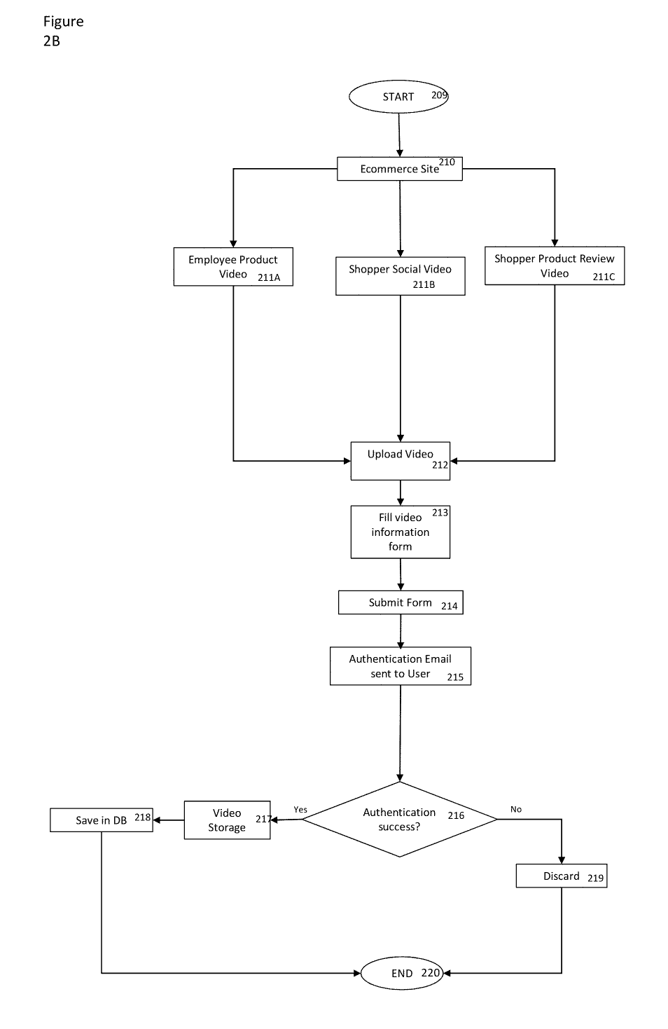

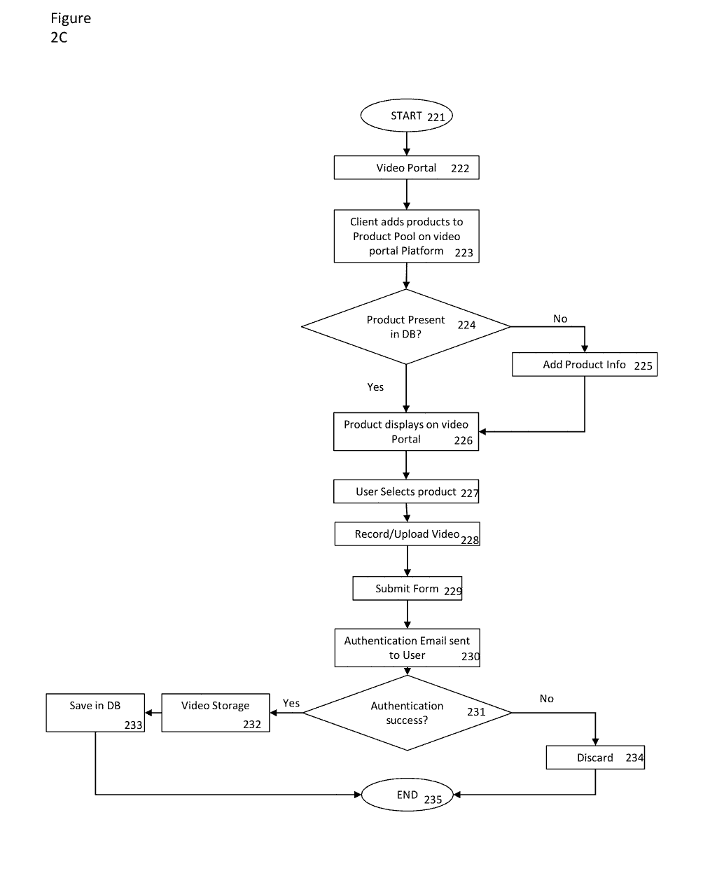

Turning now to FIG. 2A, there is shown an exemplary social media ingestion process. In this non-limiting exemplary process, video is obtained from one or more social media channels. The process starts with 201. Upon starting the process, one or more social media channels 202 are visited. API (application programming interface) authentication is preferably performed in Stage 203. This enables the computer to automatically visit and retrieve videos from the social media channel based on search criteria set by the client-user and executed by the platform.

Automated platform searches for videos that are based on product information and/or using global video-use data, may optionally be performed in 204A. The client-user, that is to say the ecommerce site owner or manager, may also search for videos, such as video reviews, social videos and/or videos from employees, based on natural language search in 204B.

Product information may optionally comprise text, images and video. Unlike keyword search, natural language search allows the user to use complete sentences to ask questions. Global-use data is platform data collected as end users engage with video content served up by the platform on ecommerce sites (e.g. user preferences and viewing habits). The end user in this context may optionally comprise one or more of a shopper user or reviewer user; the ecommerce site owner or manager may also optionally provide use data.

Machine learning algorithms then filter for relevant content in Stage 205 from the raw user-results obtained from social media in the previously described Stages 204A and 204B. The machine learning algorithm can then prioritize content based on global video-use preferences in Stage 206.

Such an algorithm could, for example, use product info, search language and global use data to filter out irrelevant videos and prioritize relevant ones for display; for example by differentiating between sneakers and running shoes, differentiating between types of video commonly watched and not commonly watched and/or the length of a video.

The videos, which are then filtered and pass these filters, are optionally saved in the database in Stage 207, and the process ends in Stage 208.

FIG. 2B relates to a non-limiting ingestion process for ingesting video from an ecommerce site. Again, the process starts with Stage 209. Preferably, the video obtaining process automatically begins with a connection to the ecommerce site in Stage 210. For example, the ecommerce site may contact the video platform. Videos are optionally uploaded through an uploading mechanism described in greater detail below and/or are retrieved from a third party site, such as a social media channel for example.

Non-limiting examples of videos which may be obtained include employee product video in Stage 211A, shopper social video in Stage 211B. These are videos which are created by the client employee users and shopper-users, that is to say the users of the ecommerce site.

In Stage 211C, optionally shopper product review videos are obtained, for example through a widget that is placed on the e-commerce site.

The ecommerce site manager can choose between three different styles of widget to place on their site. A social widget is for general/customer experience videos, and would be labeled and displayed as such. A product widget is for product-specific video reviews. An employee video is generated by a client employee through an employee widget, and is labelled as such.

Once the videos have been obtained from Stages 211A to 211C, then optionally the video is uploaded through the widget in Stage 212.

Each widget style offers the end user (of that widget) the option of uploading an existing video to the platform, or recording one in the widget right on the ecommerce site page via their hardware device's video camera, which is operated automatically by code in the widget.

Next, the video information form is filled in Stage 213, which may optionally include information such as the email address of the person who created the video, the fact that they assigned their ownership rights, the subject of the video, and any tags they may want to add to the form. The form is submitted in Stage 214. Then a verification email is sent to the shopper-user in Stage 215 to verify the identity of the shopper-user. Once the video is ingested, a verification email is sent to the video creator, and the creator's email is verified, the video is stored in the database on the platform.

Upon such verification in Stage 216, optionally the video is stored in Stage 217, for example, in the temporary video storage, and after that Stage, is saved in a database in Stage 218. If the authentication does not succeed, then the video is discarded in Stage 219, and the process ends in Stage 220.

The verification process is performed to ensure that the video is actually coming from the person listed in the upload form. Preferably, employees of the ecommerce site use the appropriate widget, which in this context would be the Employee widget instead of the product or social widget. Such employees preferably still need verification.

FIG. 2C relates to an exemplary ingestion method for ingesting from the ecommerce video portal. The ecommerce video portal is optionally an end user portal for collecting and displaying video product reviews. Reviewers may optionally upload to the portal in order to get free products (supplied by clients) in return for an honest video review. All videos collected on the portal are streamed to corresponding widgets on client ecommerce sites. Users go to the portal after it comes up in search to find video product reviews on a wide range of products. Optionally, this location is also where clients login to see their dashboards.

The process starts in Stage 221. It then opens the ecommerce portal in Stage 222. The client-user adds listings for products available for review to the product pool on the video platform in Stage 223. It is then determined whether the products are available for display on the portal in Stage 224, as information is present in the database. If information is not present in the database, it is added in Stage 225.

The product is then displayed on the portal in Stage 226. The reviewer-user can select a product on Stage 227. If it is present, then a video can be recorded or uploaded in Stage 228.

Again, the process continues through those Stages of filling in the form in Stage 229, the verification email to the reviewer-user in Stage 230. If verification succeeds, as shown with regard to the diamond in Stage 231, then the video preferably moves temporarily to video storage 232 and then permanent database storage in Stage 233. Otherwise, it's discarded in Stage 234, and the process ends in Stage 235.

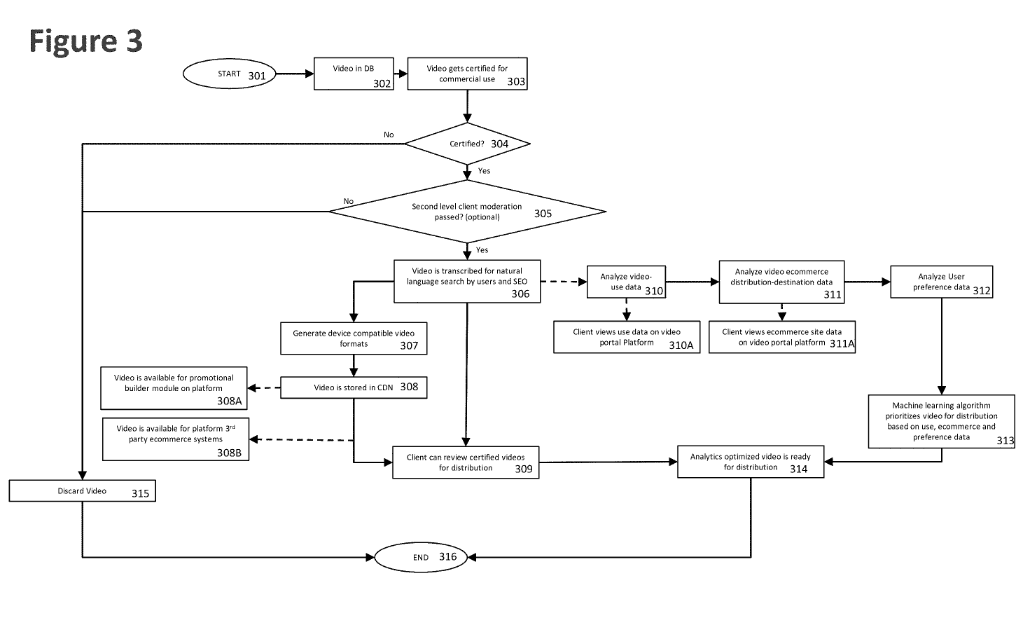

FIG. 3 relates to a non-limiting exemplary process for processing the video, as previously described. Once the video has been uploaded, then the process for video processing begins in Stage 301. The video is retrieved from the database in Stage 302. It is moderated and certified for commercial use in Stage 303. For example, the video is examined for inappropriate language, behavior or images such as nudity. If it is not certified in Stage 304, then the video is discarded in Stage 315, and the process ends in Stage 316.

Assuming, however, it is certified, then turning back to the “yes” branch, in Stage 305, the video optionally undergoes second level moderation, for example by the ecommerce site manager or owner. If the video fails this second level moderation, then the video is discarded in Stage 315, and the process ends in Stage 316.

If the video passes, then in stage 306, the audio track of the video is transcribed to text for natural language search by the client-users and shopper-users and also for SEO (search engine optimization). Video transcription allows search engines to see specifically what content is contained in each video, based on the text version of the audio track, facilitating natural language search (otherwise the video is just a media object).

A device compatible video format or formats is generated in Stage 307. For example, the video may optionally be compressed and rendered more appropriately for a smaller screen for mobile, but may also optionally be rendered in a higher format and in a greater DPI, a greater amount of bandwidth then being required, perhaps for a desktop computer.

The video is preferably stored in a CDN (content delivery network), in Stage 308. It can then be available for the platform promotion builder module on the platform in Stage 308A.

In addition, preferably, the video is made available for the platform promotion builder module, third party commerce systems, and other distribution systems in Stage 308B. Optionally all such distribution is made through a CDN, for example with an embed code.

Next, the client-user (that is the ecommerce site or its manager) can review the certified videos for distribution Stage 309.

Next the analytics-optimized video is provided for distribution in 314. The process then ends in Stage 316.

Turning back now to Stage 306, where the video is transcribed for natural language search by client-users on the platform and shopper-users in online search, then preferably the video-use data is analyzed in Stage 310. Video transcription allows search engines to see specifically what content is contained in each video, facilitating natural language search (otherwise the video is just a media object).

The client-user can view the video-use data on the platform in Stage 310A. Next, the video ecommerce distribution-destination video-use data is analyzed in Stage 311. Video-use-data describes where the video is used, who uses it, how it's used, and how it is responded to by end users. This information is correlated to the natural language search text entered by the shopper-user to display the most relevant video to the shopper-user. Ecommerce destination site data refers to shopper-user journey data, that is, all actions taken from watching the video to purchasing the product, and can be also viewed on the platform in Stage 311A. Next, the user-preference data is analyzed in Stage 312. User-preference data refers to data depicting actions shopper-users take with the video in relation to particular types of products and types of reviews (unboxing, end-to-end etc).

Next, in Stage 313, the machine learning algorithm prioritizes video for distribution based on ecommerce site data, video-use and preference data. Again, the analytics-optimized video is ready for distribution in Stage 314.

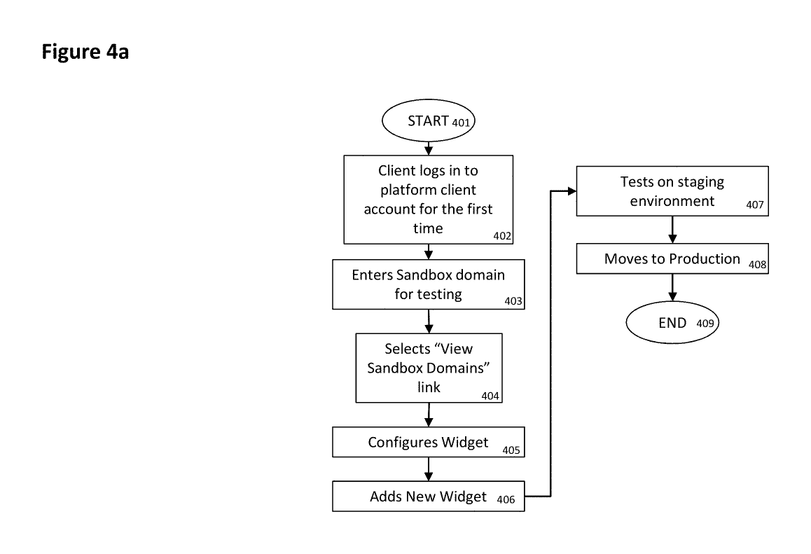

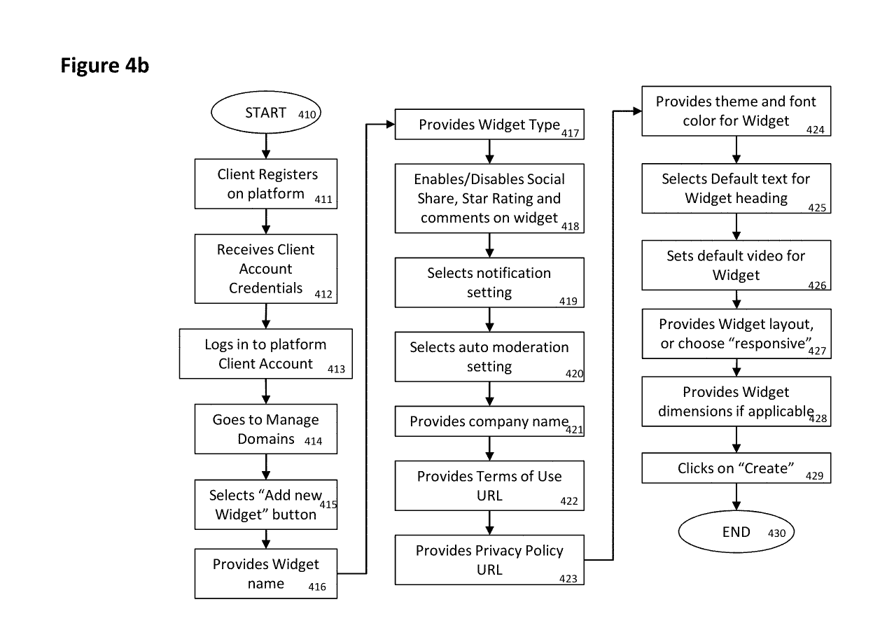

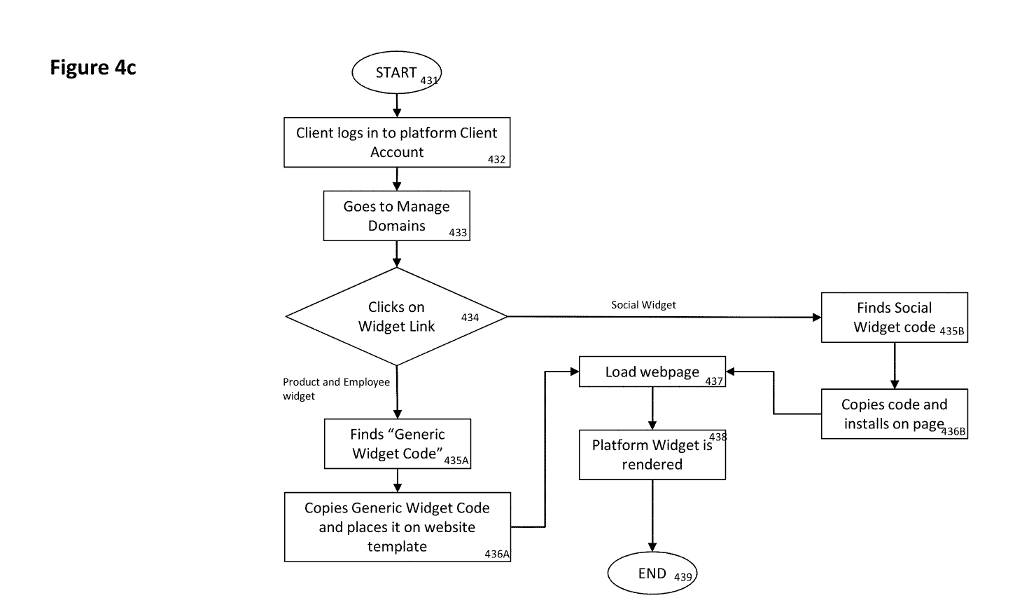

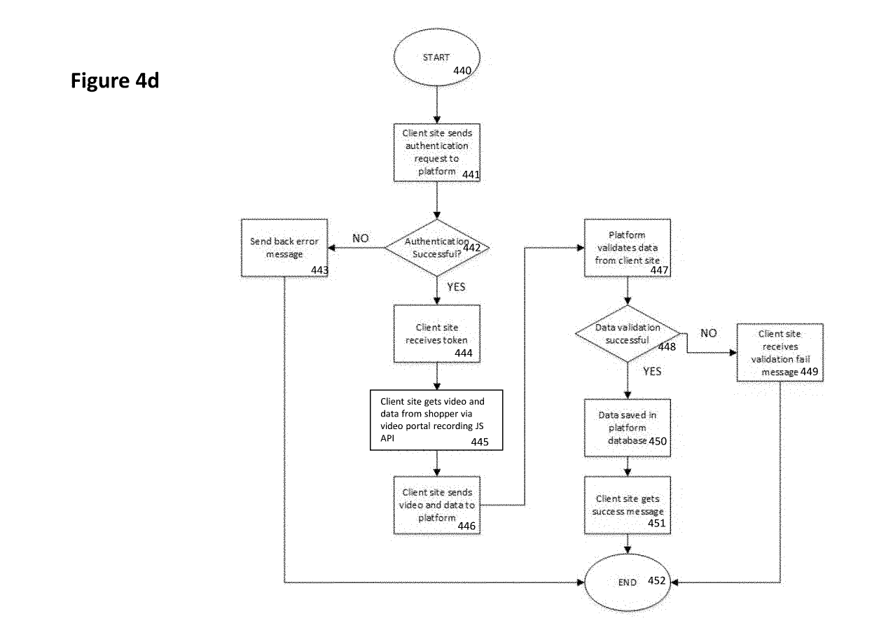

In FIG. 4A, optionally sandbox domain testing is performed in an exemplary process. The process starts with Stage 401. The client-user logs into the platform client account for the first time in Stage 402. Now, Stage 403, they enter the sandbox domain for testing. This allows the ecommerce client-user to test the platform on a non-public domain and understand what they can do with the platform and the limitations therein. In Stage 404, the client-user selects “view sandbox domains” link. The client-user then configures the widget in Stage 405. This is the widget that would appear on the ecommerce site and which would allow the ecommerce site to more easily receive video reviews from shoppers.

The client-user may then optionally add the new widget in Stage 406 to a staging environment and can then test it on the staging environment in Stage 407. The staging environment may optionally include a duplicate of the client-user's own ecommerce site or a simple ecommerce site that allows the client-user to see how the widget would behave under different circumstances. Once testing has been performed to the client-user's satisfaction, then the widget is moved to production in Stage 408, and the process ends in Stage 409.

FIG. 4B is an exemplary process for creating and modifying the widget, which allows the ecommerce site to ingest videos, display the videos and receive videos from other sites through this particular widget.

In Stage 410, the client-user registers on the platform in Stage 411. The user-client receives the client account credentials in Stage 412 and logs onto the platform for the client account in Stage 413. The client-user then goes to Manage Domains in Stage 414. These domains optionally relate to particular client domain names.

Then the process of creating a new widget is started in Stage 415. The product widget code is embedded on the client's ecommerce template and, as a result, widgets appear on all product pages in the location specified on the template. Client-users can then login to their dashboard and turn off widgets on specific pages. Employee widgets work in the same way as product widgets. Social widgets are created on a per-widget basis and can be placed on any individual page(s). The client-user now begins the process of configuring their widget's design, layout and size. It is only when they finalize the process and click on “Create” that the widget code is created.

A widget name is provided in Stage 416, and the widget type is provided in Stage 417. Next, the client-user can enable or disable the social share, star rating, and comments on the widget in Stage 418. The client-user can then select the notification setting in Stage 419 and also the auto-moderation setting in Stage 420.

Notifications are sent to the client-user when a new video is approved by the moderation team. The client can choose how often they want these notifications to arrive (daily, weekly, monthly, per video). If auto-moderation is turned on, videos will be pushed to the widget as soon as the moderation team has certified them as commercially viable. If auto-moderation is turned off, the client-user has the ability to watch all videos prior to them being pushed into the widgets.

In Stage 421, the client company name is provided. This will be used in the reviewer terms of service agreement displayed in the widget. And the terms of use text, or 422, is also provided. This will allow the ecommerce site to state how the videos will be used, under what circumstances they will be used, what kinds of videos are allowed or not allowed and the ownership rights and licenses associated with the videos. The client-user then provides the privacy policy URL in Stage 423.

The client-user can then select the theme and font color for the widget in Stage 424 for skinning it. The client-user then selects the default text of the widget heading in Stage 425 and the default video for the widget in Stage 426. Default settings are the settings that will appear in all widgets rendered from and on the client domain. The default video/image is the call-to-action video or image encouraging shopper-users to record or upload a video that is displayed in the widget if there are no user videos associated with this widget, so that the widget does not come up empty.

The client-user then provides the widget layout in Stage 427. The layout is the last step in widget configuration. Once color defaults are decided, horizontal, vertical or single layout is selected. Single widget layout dimensions are set and cannot be altered, however the client can customize horizontal and vertical widget dimensions to their preference and integrate them into the look and feel of their website.

Next, the client-user provides the widget dimensions in Stage 428. Alternatively the client-user may select a responsive layout in stage 427, such that dimensions would remain relative in stage 428.

The client-user then clicks on “create” in Stage 429, and the process ends in Stage 430.

In FIG. 4C, the dynamic widget is installed in an exemplary process. The method starts with Stage 431, where again the client-user logs into the platform client account in Stage 432, as previously described. The client user goes to manage the domains in Stage 433, also as previously described, and clicks on the widget link in Stage 434. This is for an already-created widget. Then the client-user finds the generic widget code in Stage 435a. The client-user copies the generic widget embed code and places it on the ecommerce website template in Stage 436a. Optionally, instead of Stages 435a and 436a, a direct deployment could optionally be performed depending on the type of site and the permissions which can be granted. It could also be done through a more manual process, optionally with a different type of embed code for social widgets which may be placed one at a time on individual pages in Stages 435b and 436b.

Next, the webpage loads in Stage 437, and the platform widget is rendered in Stage 438, and the process ends in Stage 439.

FIG. 4D relates to a non-limiting, exemplary method for manipulation and customization of video ingestion and display through an API (application programming interface). Optionally, in this example, a widget is not used. It is understood throughout the text that when a widget is mentioned, the function or flow could optionally be replaced with an API as described herein.

The process starts in 440. Client site sends platform API authentication request in stage 441. It is determined whether authentication is successful in Stage 442. If authentication is not successful, then in stage 443, an error message is returned and the process ends in stage 452.

If authentication is successful, the client site receives an authentication token in Stage 444.

Client site requests video and data through video ID in Stage 445. Client site sends video and data to the platform through the platform API in stage 446. The platform validates the client data as being present in Stage 447. It is then determined whether validation is successful in Stage 448.

If validation is not successful, then a fail message is sent in Stage 449 and the process ends in Stage 452.

If validation is successful in Stage 448, then data is saved in the platform database in Stage 450 and the client site receives a success message in Stage 451. The process ends in Stage 452.

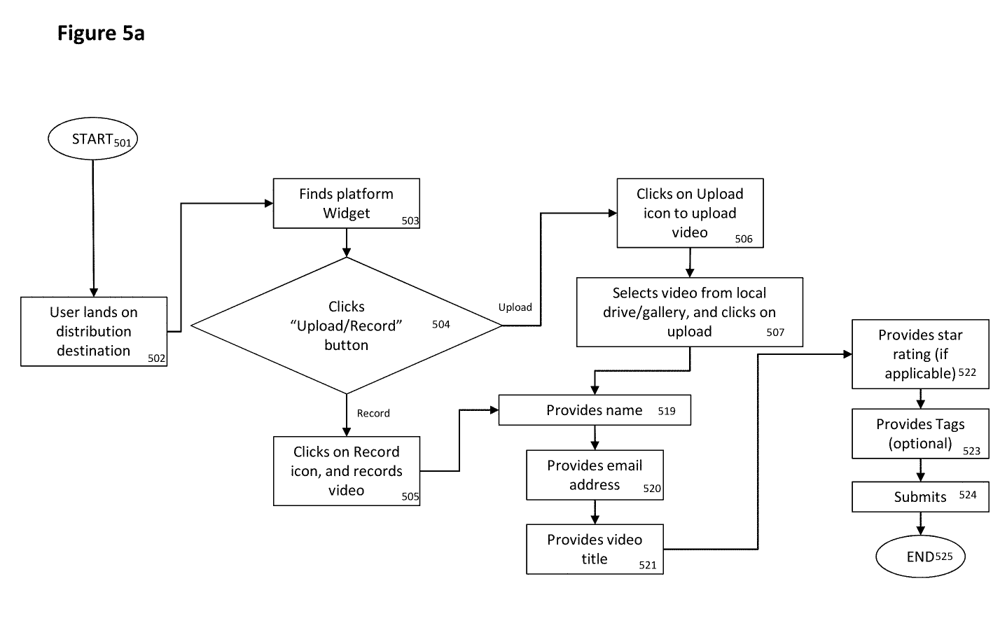

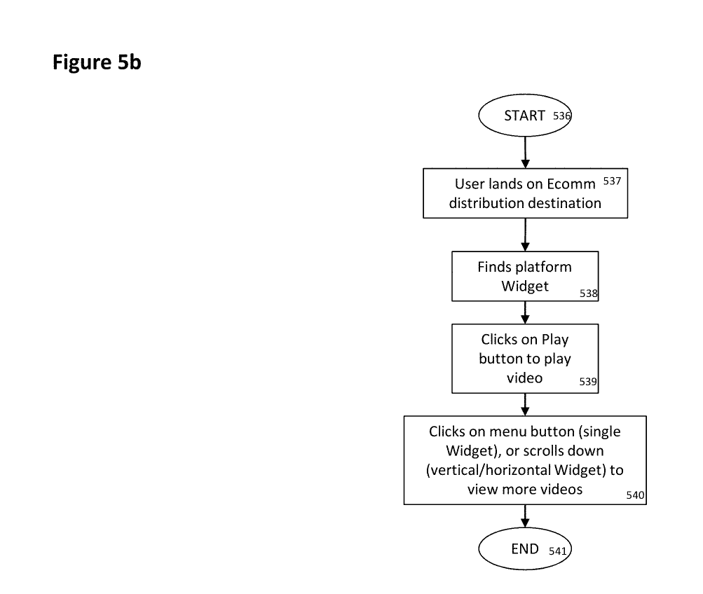

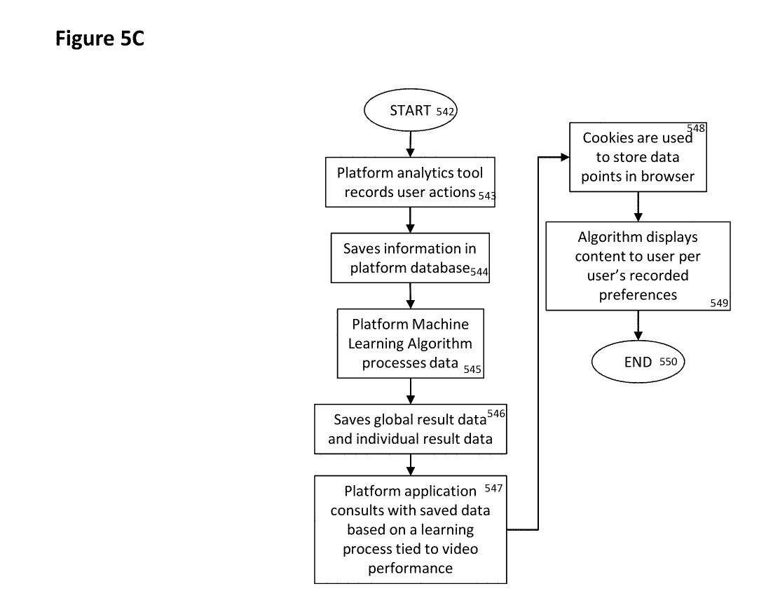

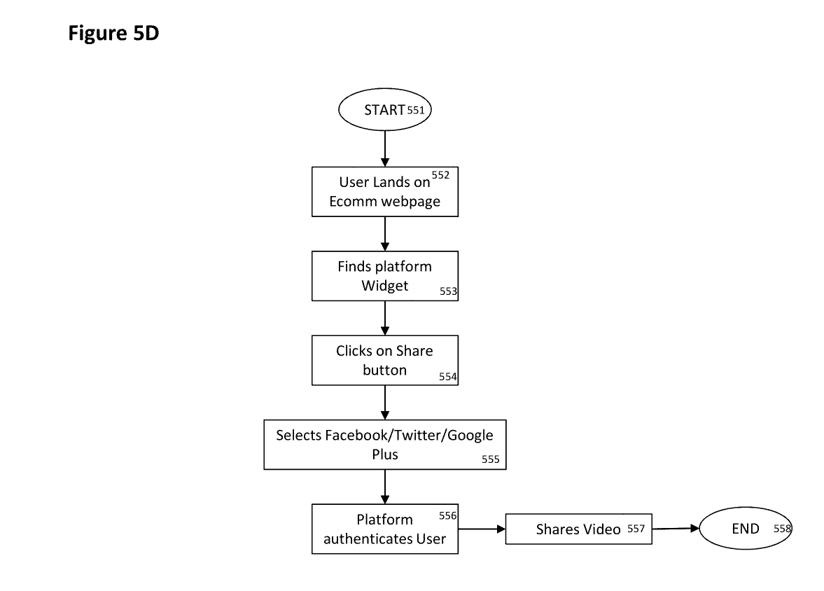

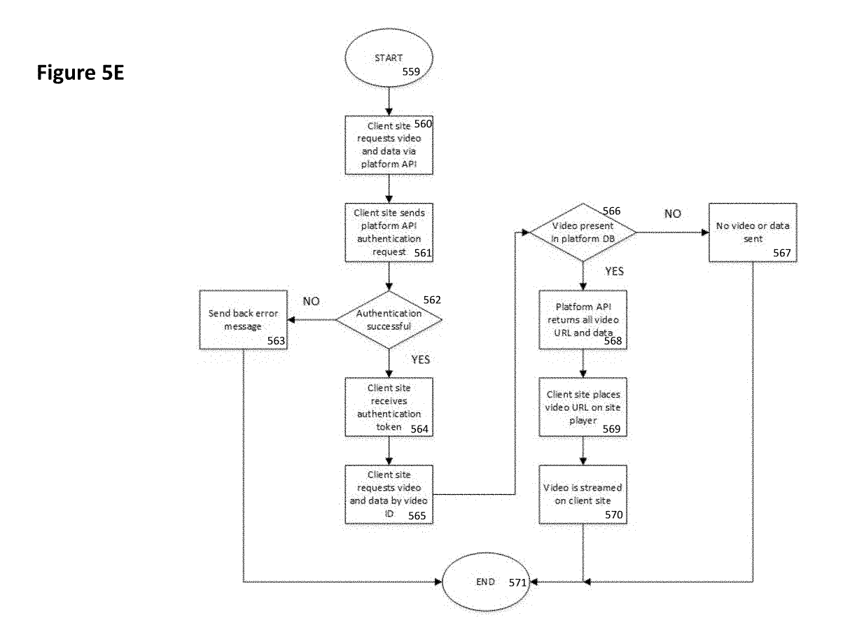

FIG. 5A relates to an exemplary method for recording of video in the widget. The method starts with Stage 501. The shopper-user lands on the ecommerce distribution destination in Stage 502, which is the ecommerce website, for example, which might actually receive the video. The shopper-user then finds the platform widget in Stage 503 because it is presented through the user interface. The shopper-user then clicks the “upload” or “record” button in Stage 504, clicks on the “record” icon, and records the video in Stage 505.

Optionally the shopper-user clicks on the upload button in Stage 504 and then uploads the video in Stage 506. The shopper-user selects the video from the local drive video gallery of the upload device such as smartphone, table or PC, and clicks on “upload” in Stage 507. Optionally, the selection could also be made from a Google drive, from a Dropbox, and from other types of drives, as well.

This allows the shopper-user to directly upload or record the video directly through the widget on the ecommerce website. If the shopper-user had a video that is already recorded, it could be uploaded, but otherwise it could be recorded through the widget itself. Optionally, the widget permits editing and other functions for video manipulation.

The shopper-user then provides their name in Stage 519, provides their email address in Stage 520, the review title in Stage 521, the star rating (if applicable) in Stage 522, and optionally provides tags in Stage 523 such as, for example, if it's an article of clothing like a shirt, describes it as a shirt, optionally with colors, optionally with season, whether suitable for men, women, and children, et cetera. Then, after adding all these tags which are optional, the user can then submit the video in Stage 524, and the process ends in Stage 525.

FIG. 5B relates to an exemplary process for actually viewing the video in the widget. The process begins with Stage 536. The shopper-user lands on the ecommerce distribution destination in Stage 537, finds the platform widget in Stage 538, clicks on the “play” button to play the video in Stage 539, then optionally clicks on the “menu” button in the single widget, or scrolls down to see available videos in a vertical or horizontal widget in Stage 540. Tiling or other types of displays are also optionally available to allow the shopper-user to select videos. The process ends in Stage 541.

FIG. 5C relates to an exemplary process for determining the order in which videos are displayed in the widget based on shopper-user data collected by the platform. The process begins in Stage 542, where the platform analytics tool records shopper-user actions in relation to the video in Stage 543. The platform analytics tool then saves the information to the platform database in Stage 544. The platform machine learning algorithm processes the data in Stage 545. The learning algorithm saves the global result data, that is, aggregate data from all shopper-users, and individual result data in Stage 546. The algorithm references this data to determine video display order, based on a learning process tied to video performance, e.g. number of times watched, number of times watching resulted in a sale et cetera, in Stage 547. Cookies are used to store data points in the browser in Stage 548, and the algorithm displays content to the shopper-user per user's recorded preferences in Stage 549. The process ends at stage 550.

FIG. 5D relates to an exemplary process for shopper social sharing. This allows shoppers, buyers, and users of the ecommerce website to share video and other information socially. The process begins in Stage 551. The shopper-user again lands on the ecommerce website in Stage 552 and finds the platform widget in Stage 553. Now, the shopper-user clicks on the “share” button in Stage 554 and selects “Facebook”, “Twitter”, “Google+”, other social channels, in Stage 555. Each of these platforms optionally, such as Facebook, Google+, Twitter, et cetera, authenticates the shopper-user in Stage 556. The shopper-user shares the video in Stage 557, and the process ends in Stage 558.

Optionally two types of interactions with social media are performed, in terms of providing videos through social media channels. Social sharing is the process a shopper-user goes through to share a video from the client's ecommerce page widget. Social Publishing is the process a client-user goes through to publish a video to their social media via their dashboard.

FIG. 5E shows a non-limiting, exemplary flow for saving data through an API by the ecommerce site. The flow starts with Stage 559. Client site requests data and video through the platform API in Stage 560. Client site sends authentication request to platform in Stage 561.

It is then determined whether authentication is successful in Stage 562. If authentication isn't successful, then an error message is returned in Stage 563 and the process ends in Stage 571.

If authentication is successful, client site receives a token in Stage 564. Client site requests video according to a video ID in Stage 565. It is then determined in Stage 566 whether the video is present. If not, then no video is sent in Stage 567 and the process ends in Stage 571.

If the video is present, then the platform returns the video URL (retrieval link) and data in Stage 568. Client site places the URL on the site player in Stage 569. The video is then streamed on the client site in Stage 570 and the process ends in Stage 571.

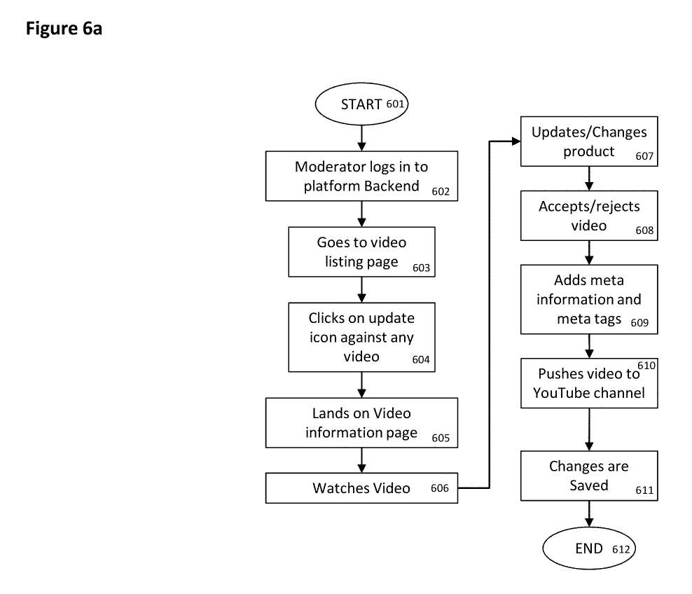

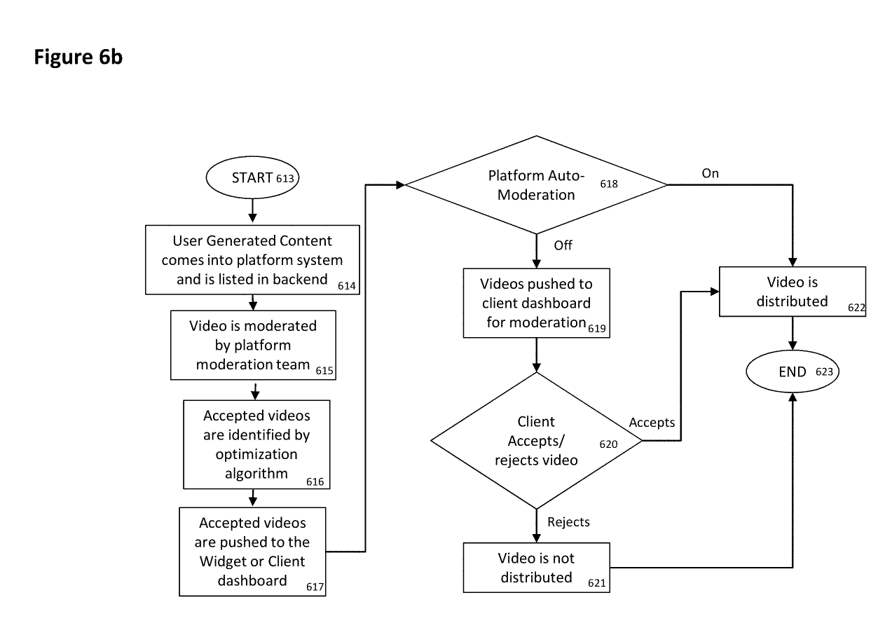

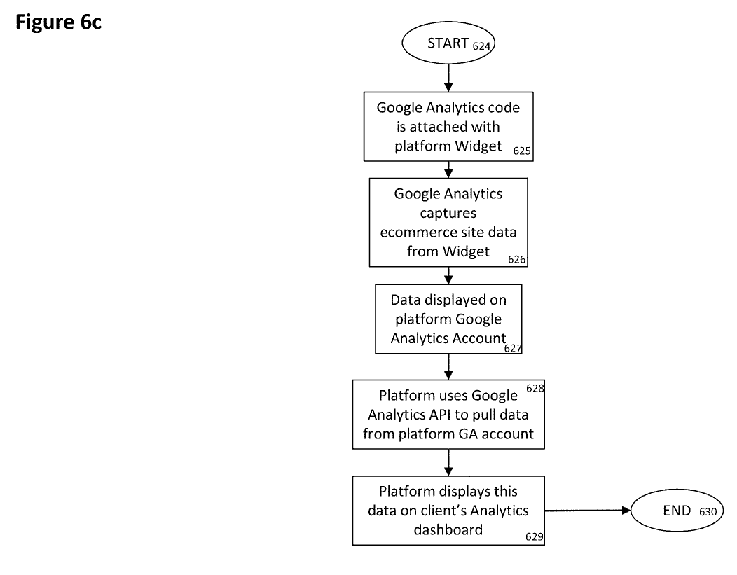

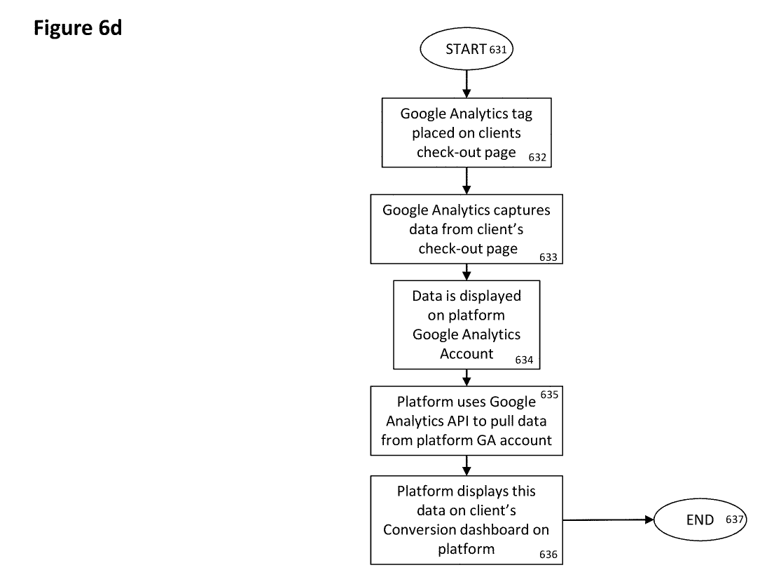

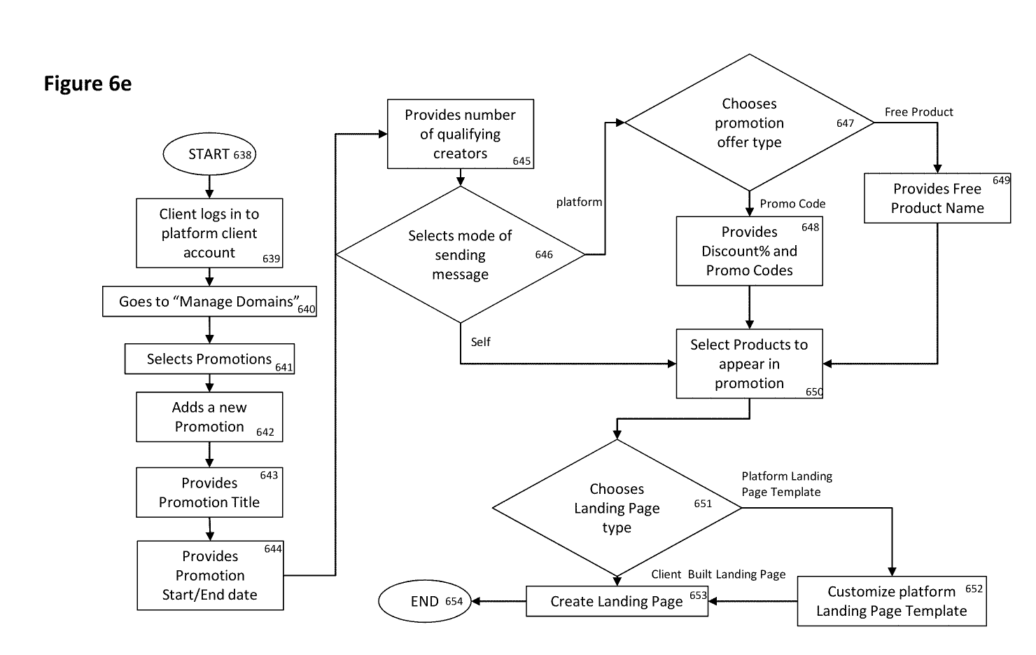

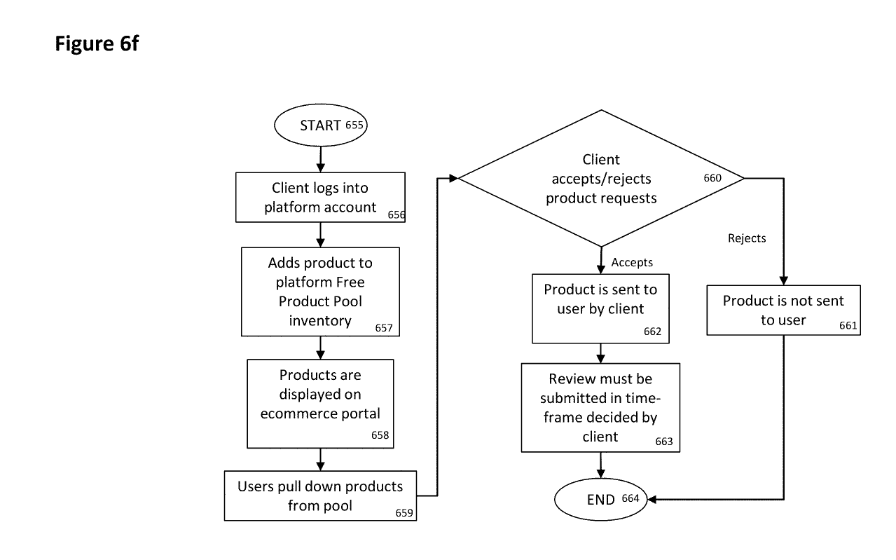

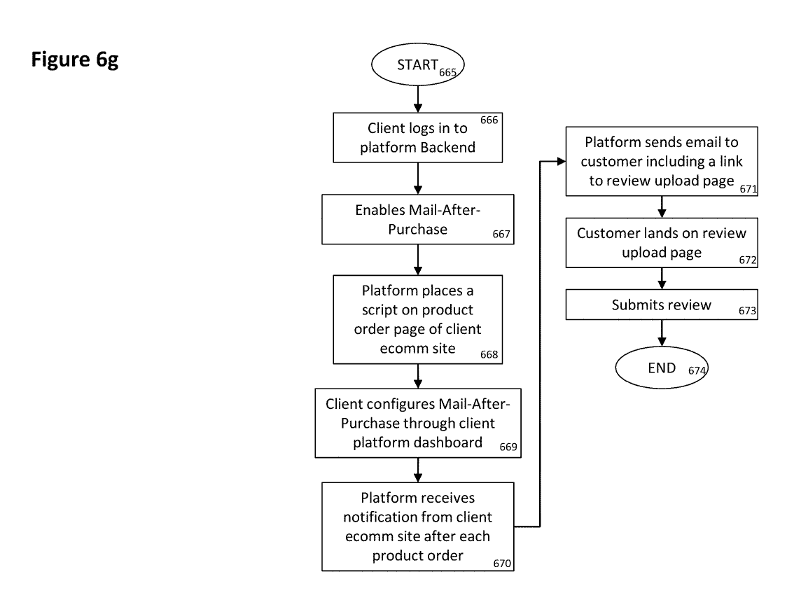

FIG. 6A relates to a non-limiting exemplary process for moderation. The process begins in Stage 601, where the moderator logs into the platform backend in Stage 602. The moderator then goes to the video listing page in Stage 603, to access a list of videos optionally ready to be reviewed and moderated. The moderator then clicks on the update icon against any video in Stage 604 and lands on the video information page in Stage 605.

Video information includes all information about the video e.g. ratings, tags, title and reviewer name. Preferably, the moderator does not see the user's email address or any other personal information.

In Stage 606, the moderator watches the video, and in Stage 607, the moderator updates or reassigns the video to the correct product widget if the video has been uploaded to the wrong widget by the reviewer-user.

The moderator then accepts or rejects the video in Stage 608, for example, according to whether or not it fulfills certain criteria. For example, does it have offensive content? Does it have offensive language? Does it have images which involve nudity or other inappropriate images? Next, in Stage 609, the moderator optionally adds limited information embedded tags. These are descriptive tags that will identify the video during search such as “inexpensive”, “durable”, “poorly made”.

In Stage 610, the moderator optionally identifies the social media destination such as YouTube. The video is pushed to YouTube once the option to push to YouTube is selected and all other moderation changes pertaining to the video have been saved. Then the moderator optionally saves it in Stage 611 in the database. The process ends in Stage 612.

Turning now to FIG. 6b, there is shown a non-limiting, exemplary process for second-level client-user moderation. Starting in Stage 613, the user-generated content is brought into the system. It is then listed in the backend in Stage 614. The video is moderated by the platform moderation team in Stage 615 as previously described. Accepted videos are analyzed and relevant videos are identified and recorded into the database by the optimization algorithm in Stage 616.

Preferably, in this process, videos are accessible through the dashboard, and pushed to the widget. The video displays in the widget, and the client dashboard, so shopper-users can interact with it through the widget and client-users can interact with it via their dashboard in Stage 617.

Next, platform auto-moderation occurs in Stage 618. If the platform auto-moderation is turned on and the video is accepted, then it is distributed in Stage 622, and the process ends in Stage 623. If, on the other hand, platform auto-moderation is turned off in Stage 618, then the videos are pushed to the client dashboard for moderation in Stage 619. For example, in this case, the client-user, may have requested an extra layer of moderation. The client-user, that is, the owner of the website or of the location where the video is to be displayed, may have requested to always, or in some cases, review the videos again, even after a first pass of moderation.

Then client-user then goes through an acceptance or rejection process in Stage 620. If the client-user accepts the video, then the video is distributed in Stage 622. If the client-user rejects the video, then the video is not distributed in Stage 621, and in any case, the process ends with Stage 623.

FIG. 6c shows a non-limiting method for analytics. As shown, the process starts in 624. The Google Analytics code is then attached with the platform widget in Stage 625.

The GA (Google Analytics) tag is placed on the client's ecommerce template by the client-user (that is the owner or manager of the ecommerce site). That tag is preferably associated with an equivalent GA account at the video portal platform. Data is then passed to the client's dashboard from this latter account.

The Google Analytics then captures the ecommerce site data, that is the shopper-user journey, that is, the steps and actions each shopper-user takes in relation to the video on the ecommerce site page, from the widget in Stage 623. For example, how many times did users interact with the widget? How many times did they upload videos? How many times did they record videos? For how long did they view videos? Which video did they review? Every time the widget is interacted with in a particular way, the Google tag activates or “fires”. Optionally, it fires generally, but alternatively and preferably, every single particular interaction of a different type causes a different analytic moment to be captured.

The data is then displayed on the platform Google Analytics account in Stage 627, and the platform uses the Google Analytics API to pull data from the platform Google Analytics account through Stage 628. Then the platform displays this data on the user-client's analytics dashboard in Stage 629 along with any other widget and other information that the platform has access to. The process ends in Stage 630.

FIG. 6d relates to a non-limiting, exemplary process for conversion tracking. As shown, the process starts in Stage 631. The Google Analytics tag is then placed on the client-user's checkout page in Stage 632. Google Analytics captures data from the client-user's checkout page in Stage 633. This type of captured data may be, optionally, a type of data that Google Analytics would capture, for example, clicking on different buttons, clicking on help, clicking on various widgets, and all the way through to payment. Each of these things may fire and may provide information which can then be pulled by Google Analytics. The data can optionally be displayed on the platform Google Analytics account in Stage 634, but alternatively or additionally, the platform uses the Google Analytics API to pull data from the platform account in Stage 635. The platform can then display this data on the client-user's conversion dashboard on the platform in Stage 636. This data will be combined with other information about the widget and analytics about the widget to show the client-user what types of customer interactions are driving sales. The process ends in Stage 637.

FIG. 6e relates to an exemplary promotions process for executing shopper-user promotions to encourage shopper-users to create videos. For this promotion process, optionally, a free or inexpensive product is provided, for example, to particular reviewer-users or shopper-users. For example, these may be influencers or shoppers who typically write reviews, and the ecommerce site would like to have them create videos. So, the process starts in Stage 638. The client-user logs into the platform client account in Stage 639 and goes to Manage Domains in Stage 640. The client-user then selects promotions, this is Stage 641, and adds a new promotion in Stage 642. Adding the new promotion may optionally involve having it offer free or inexpensive product, product discounts via a promotion code, or whatever the client decides to pick. The client-user then provides a promotion title in Stage 643, and the start/end date in Stage 644, if, in fact, this promotion is going to be offered for a limited time. The limitation may be that the client-user specifies to have the reviewer-user or the shopper-user who is taking advantage of this promotion do so by a certain date. Now, the start/end date would, for example, control when the shopper-user who is to receive the promotion discount or free product is to be notified.

The user-client then provides the quantity of qualifying video creators in Stage 645. Optionally, the client-user may decide exactly which creators are allowed to have access to it, or it may simply be that once a certain number of people have used the discount, the offer expires. Next, the client-user selects the mode of sending the message announcing the promotion and the promotional offer to shopper-users in Stage 646. They can choose to have messages automatically sent through the platform system via email or social media or third party app, or they can send their own messages through their systems including organizational or personal social media accounts, apps or email.

In the dashboard, a client-user (that is, the ecommerce site owner or manager) can choose whether to automate all promotional messages to their shopper-users through the video platform system dashboard, or send their own messages. If the client chooses to have messages automated through the video platform system, the video platform needs to receive information regarding the details of the promotion so the offer discount/free product can be applied to qualifying reviewers. If the client-user chooses to send their own messages, then they will be coordinating the reward, so the video platform system does not need to receive offer details. Preferably, the system links videos submitted through a promotion to the associated widgets for the products in the promotion, ensuring that they qualify for the discount/offer.

If the client-user selects the mode of sending messages to be the platform, then the client-user chooses the promotion offer type in 647. If it will be free product, then the free product name is provided in 649. If it will be a promotional code, then at 648, the client-user provides the discount percentage and promotional codes or some other promotional offer. Otherwise, the client-user would send their own messages in Stage 646. The client-user would then select the products to appear in the promotion in 650.

Next, in 651, the client-user chooses the landing-page type. For example, if the landing page is provided as a client-built landing page, then the client would create the landing page in 653 and use product page URL's provided by the promotion module to create links from images of the products on the landing page to the correct associated widgets on the client ecommerce site. If the client-user selects to use a platform-landing page template, then the client-user would customize the platform-landing page template in 652 and would then customize the landing page in 653. The landing page would automatically include the URLs for the selected products, and provide one URL for this landing page to the client-user for use in promotional materials. The process ends in 654.

FIG. 6f relates to a non-limiting, exemplary process for creating or otherwise determining a product pool, for example to attract reviewers and potential shoppers who would also create reviews. For example, the pool could include free or discount products for review. In 655, the process starts. The client logs into the platform account in 656 and adds a product to the platform Free Product Pool Inventory in 657. The products are then displayed on the aggregate ecommerce video site in Stage 658, and reviewer-users can request access to products in the pool in 659. The client-user can review and may optionally accept/reject product requests from reviewer-users in 660. So for example, the ecommerce site may advertise this to qualified reviewer-users, and qualified reviewer-users may optionally be those who have reviewed a certain number of products, whose reviews gathered a certain number of social likes or shares et cetera. If the client-user accepts the reviewer-user's product request, the product is sent to the reviewer-user in Stage 662, and the video review has to be submitted in a time frame decided by the client-user in 663, and the process ends in 664. If, on the other hand, the product request is rejected, the product is not sent to the reviewer-user in 661, and the process ends in 664.

FIG. 6g relates to a non-limiting, exemplary process for email marketing automation to encourage shopper-users to create videos. In Stage 665, the process begins. The client-user then logs into the platform backend in 666, enables Mail-After-Purchase in 667. The platform places a script on the product pages or a page of the client ecommerce site in 668. The client configures the Mail-After-Purchase through client platform dashboard in 669, and the platform receives notification from the client ecommerce site after each product order in 670. The platform sends an email to the shopper-user who has purchased the product, including a link to a review-upload-page in 671.

For user convenience, rather than take the user to the product page widget from the email, the email may optionally include a direct upload/record page that is associated to the corresponding product widget. For example, the email could include a link to induce the shopper to send a review, and then the shopper who elects to send a review uses the video upload page in 672. Next the shopper submits their review in 673. The process ends then in 674.

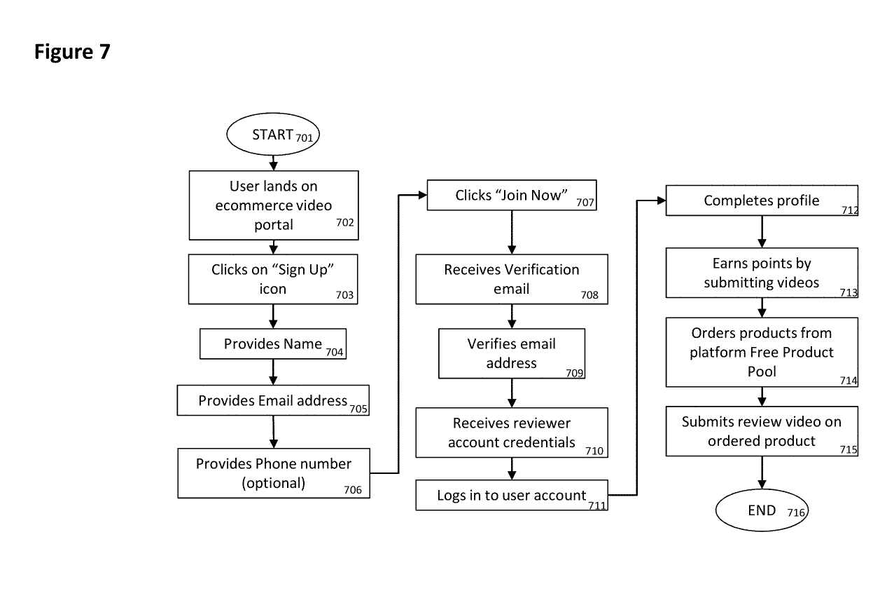

FIG. 7 relates to a non-limiting, exemplary process for a video reviewer to sign up for the product pool. In this particular case, a video reviewer may optionally be induced to submit additional videos, for example, a well-known vlogger or blogger who submits videos that go viral. Such a person could be an influencer on YouTube or an influencer in a particular locale. If, for example, an ecommerce site has decided that they want to increase their site's reach geographically or demographically, than a vlogger or reviewer who fits these criteria could be induced to submit more videos.

The process starts in 701, and the user lands on an aggregate site in 702, which preferably also includes the product pool.

The reviewer-user then clicks on the sign-up icon in Stage 703, provides the username in 704, the email address in 705 and optionally provides a phone number in 706. The reviewer-user then clicks Join Now in 707. Optionally, other information that is be provided is demographic information as previously noted, to help ecommerce sites get certain types of reviews from certain types of reviewers—e.g. for some ecommerce sites, reviewer location may be an important data point. For example, they may have less-expensive fulfillment from particular areas, or perhaps they want to expand overseas.

The reviewer-user receives the verification email in Stage 708 and verifies their email address in Stage 709, for example, by clicking on the link in the email. The reviewer-user then receives reviewer account credentials in 710 and logs into the user account in 711. The reviewer-user completes the profile in 712 and earns points on the ecommerce portal by submitting videos in Stage 713. Optionally, the reviewer-user would be requested to include, for example, a particular hashtag to make it easier to track. The reviewer-user then orders products from the Platform Free Product Pool by using the points in Stage 714 and then submits a video on the ordered product in Stage 715. The process then ends in Stage 716.

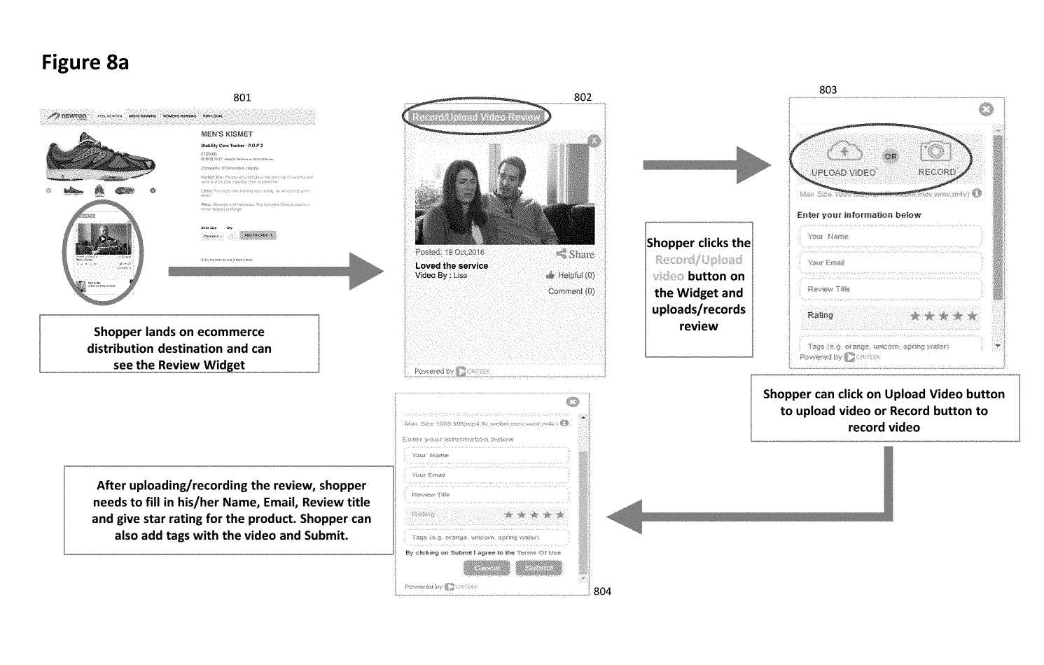

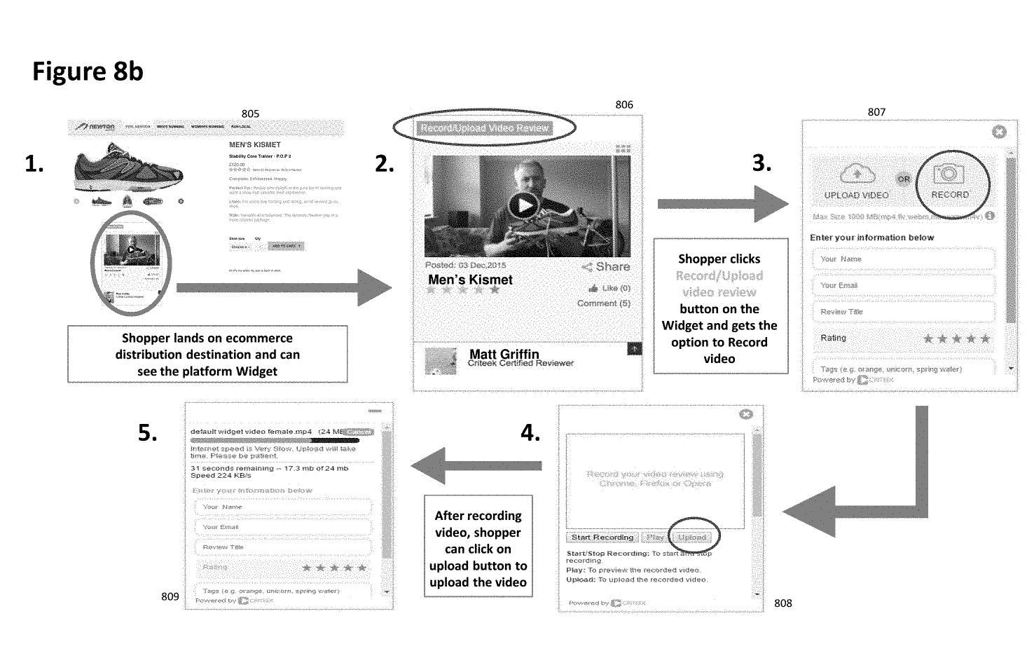

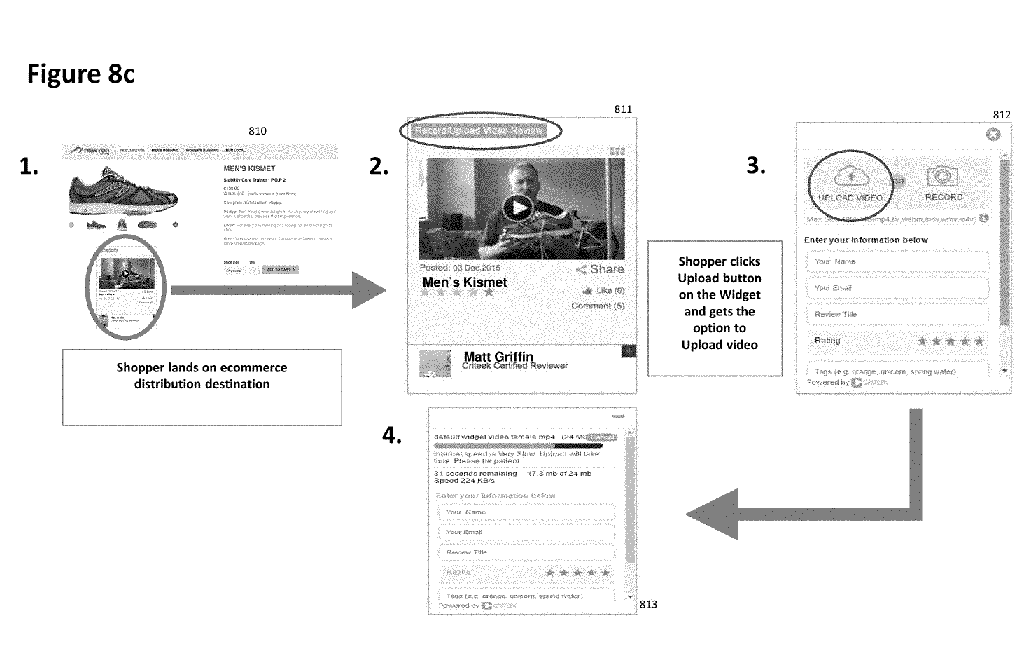

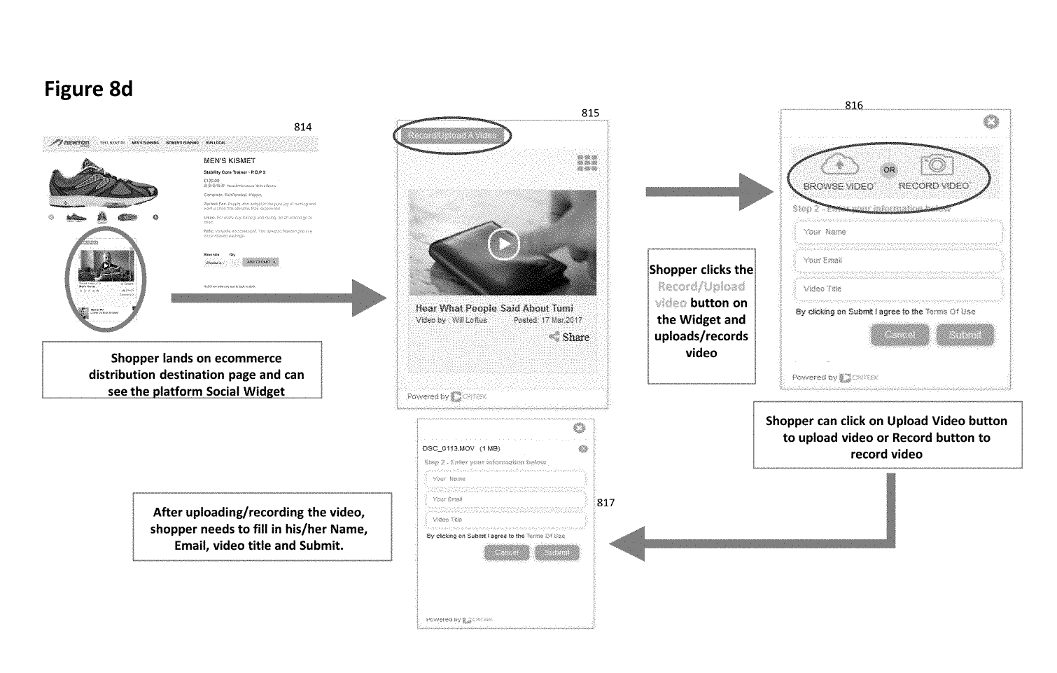

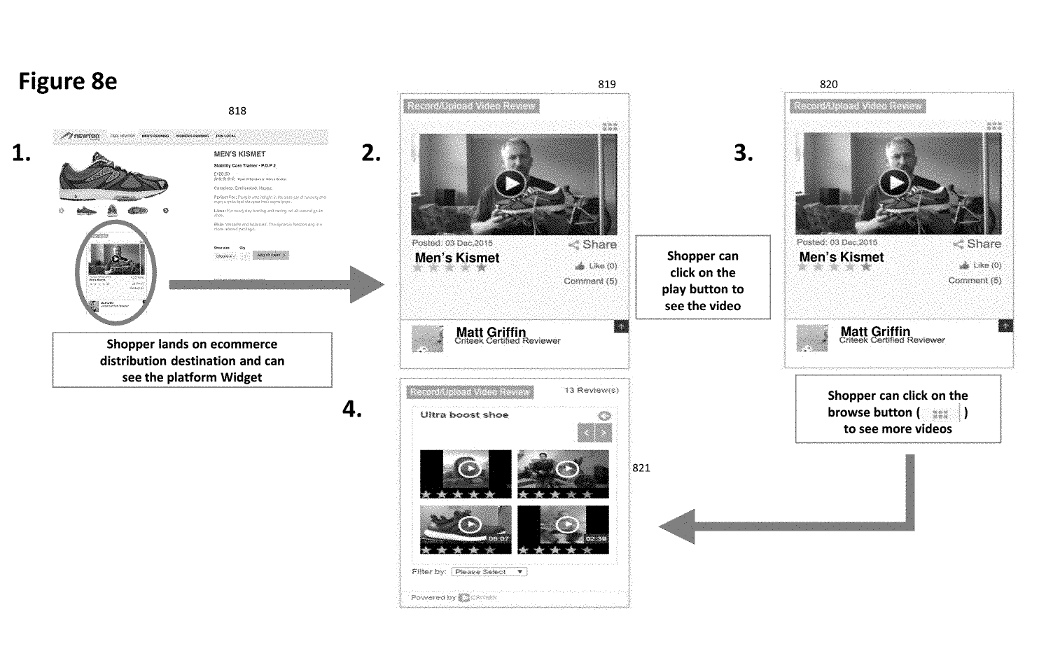

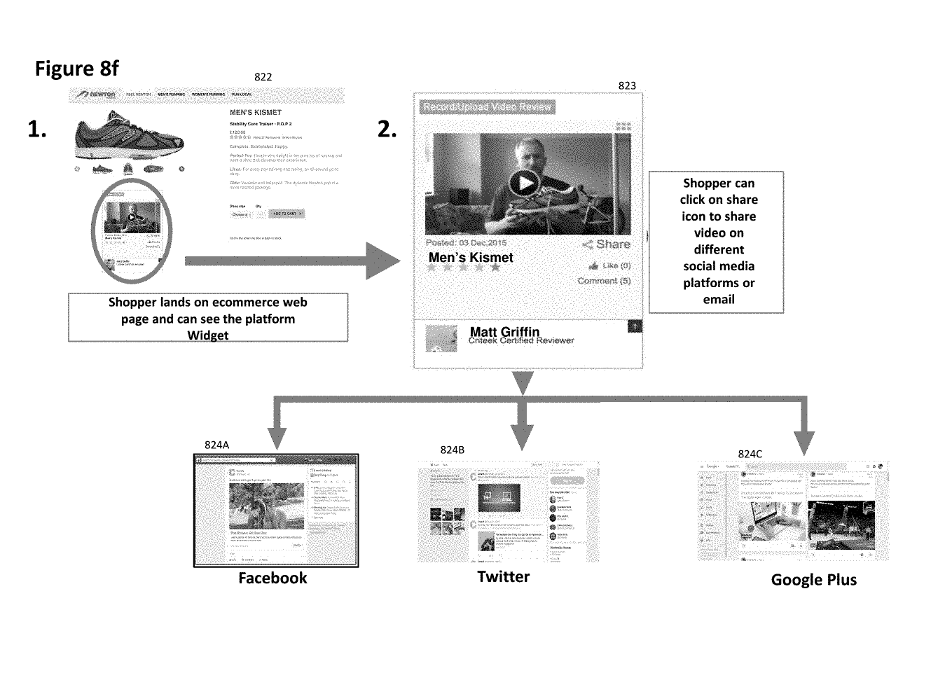

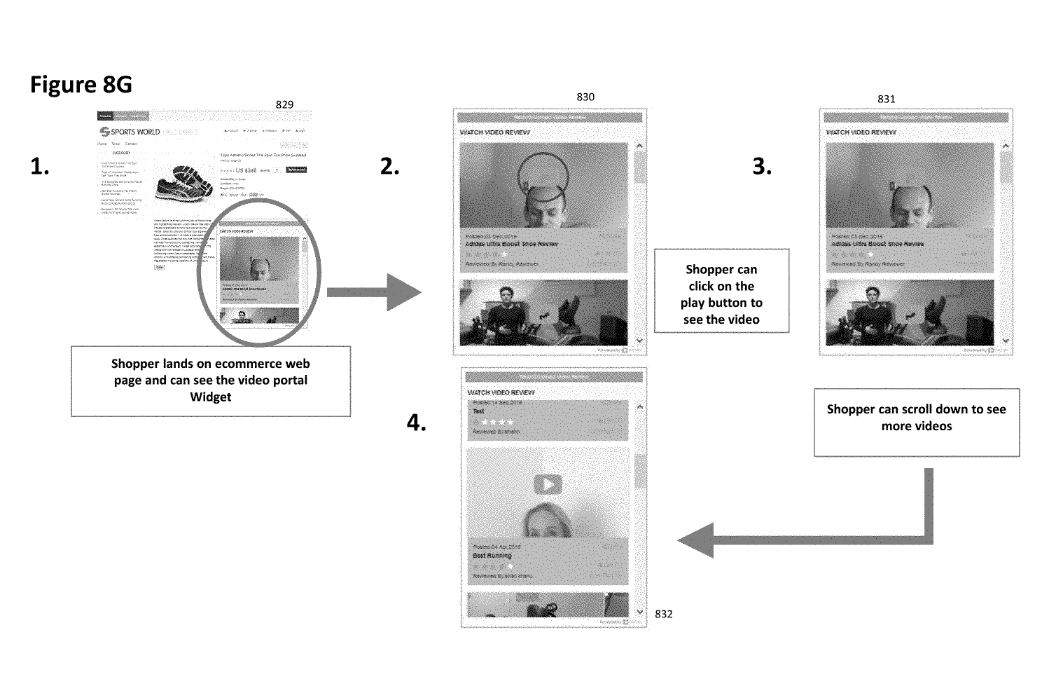

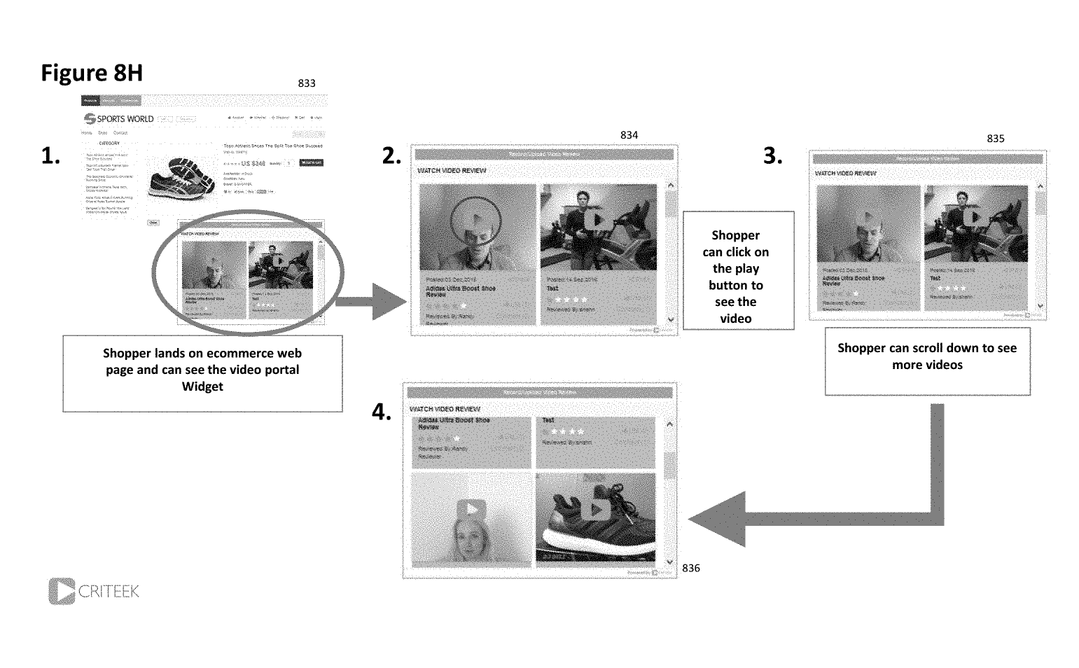

FIG. 8a relates to an exemplary, non-limiting process for providing a review. So first, as shown in 801, the shopper-user lands on the ecommerce-distribution destination and can see the review widget. So, in this case, the ecommerce site is shown, and a shoe is shown as potentially being sold, with some descriptive text on the right. The review widget is shown by the gray circle. The widget shows different video reviews that the shopper-user could view and also indicates that commenting, recording and uploading functionality is available. Next, in 802, the shopper-user would record and upload the video review. Here this is shown with the shopper-user having just recorded and/or uploaded it (optionally recording is followed by uploading). This video can be then shared socially by other shopper-users. It shows who submitted the video, the title of the video and other information. Other shopper-users can comment on it, say whether it's helpful et cetera. Next, the shopper-user clicks the Record/Upload Video button on the widget and records and uploads the review.

Optionally the reviewer can select the upload/record button from anywhere, at any time within the widget.

In Stage 803, in this case, the shopper-user decides to upload or record a video. They enter their information, name, email, title, rating, any tags for example, and then cause the video to be uploaded or recorded by clicking on Submit in Stage 804. The shopper-user would need to fill in the additional information as shown.

FIG. 8b shows a non-limiting, exemplary process which relates to recording through the widget itself as opposed to uploading. So again, in Stage 805, the shopper-user lands on the ecommerce-distribution destination and can see the platform widget. The shopper-user can then view other shopper's videos and can choose to record and upload their own by pressing the record/upload button in Stage 806.

In 807, the shopper decides to record a video by clicking on the record button. In 808, after recording, the shopper-user can then play it back to see if they are satisfied with what they have recorded, and could then touch the upload button to actually upload it. In Stage 809, it is noted that the upload may take time. The shopper-user is notified regarding the speed of their Internet connection and the implications of their connection speed on upload time, and then other information is added as previously described.

FIG. 8c relates to a non-limiting, exemplary process for uploading as opposed to recording. Again, the shopper-user lands on the ecommerce-distribution destination in 810 and decides to record/upload the video review in 811. The shopper clicks the Upload button on the widget and gets the option to upload the video. And in Stage 813, the uploading process of selecting a video from the video gallery on the shopper-user's device or from another source such as Dropbox or GDrive (Google Drive) begins, and again, uploading may still take some time, in which case the shopper-user is notified.

FIG. 8D relates to a similar non-limiting, exemplary process for uploading, but with special social widget options, for increasing sharing possibilities.

FIG. 8e relates to a non-limiting process to assist a shopper-user who may want to view videos. So in 818, the shopper-user lands on the ecommerce-distribution destination and can see the platform widget. Now, the shopper decides in 819 to click on the Play button to actually see the video, so the Play button is distributed quite prominently there in the image. The shopper can view the video and see the whole review, and then the shopper can click on the Browse button in stage 820 to see more videos and select the ones they want to view.

In 821, the shopper-user then browses through different videos and may optionally see different video review thumbnails, optionally filtered by a particular date, a particular product or a particular view of the product and displayed in order of relevance by the machine learning algorithm as previously described.

FIG. 8f relates to a non-limiting, exemplary process for sharing various videos from a widget. So as shown in Stage 822, the shopper-user lands on the ecommerce webpage and can see the platform widget which is circled there on the left. In Stage 823, the shopper-user can click to share a video by clicking on the Share icon, and the shopper-user can choose to share the video on different social media platforms or by email. So for example, Facebook is shown as a sharing option in 824a, Twitter is shown in 824b and Google+ is shown as sharing in 824c. If being shared by email, then optionally the email would feature a link that the email recipient could then click on, if they receive the email, to view the video.

FIG. 8G relates to an additional exemplary process for showing the user multiple videos. As shown in Stage 829, the shopper-user lands on the ecommerce website and can see the widget as shown in the gray circle. In Stage 830, the shopper can click on the Play button to see the video. But if the shopper didn't like the video or liked the video and wanted to see more videos, the shopper-user can scroll down to see more videos in Stage 831, and then, in Stage 832, can pick a different video. So, this is a continuous-scroll form that displays thumbnails of all the videos for a particular product versus the browse button process previously described in Stage 820.

FIG. 8H relates to an exemplary method with a different type of layout for video display. In this case, multiple videos are shown in the gray circle in Stage 833. The shopper-user could then select the Play button to view one video in Stage 834. The shopper-user can optionally see multiple videos on one line in 835, and then scroll down to see more videos in 836.

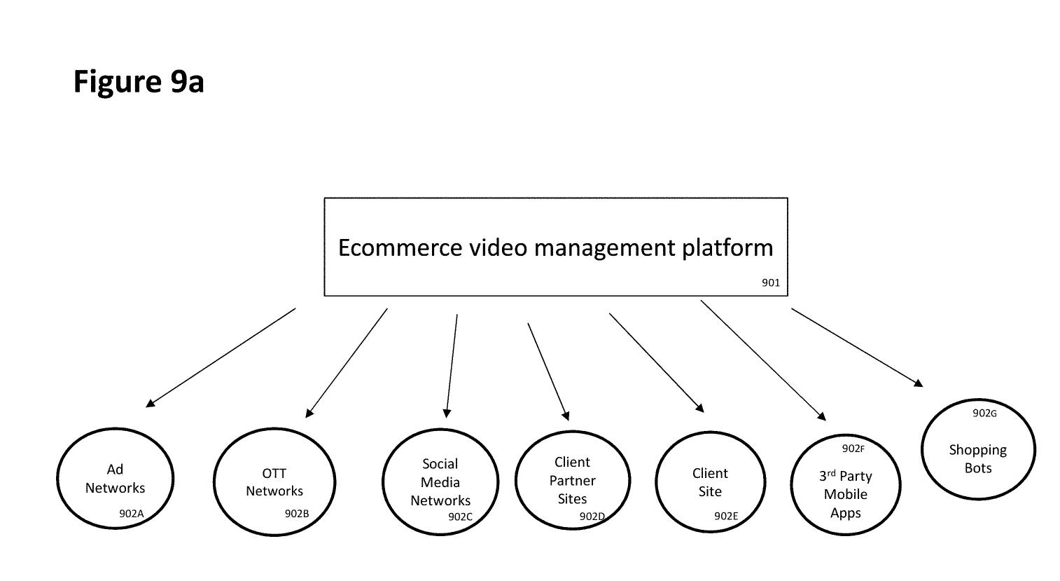

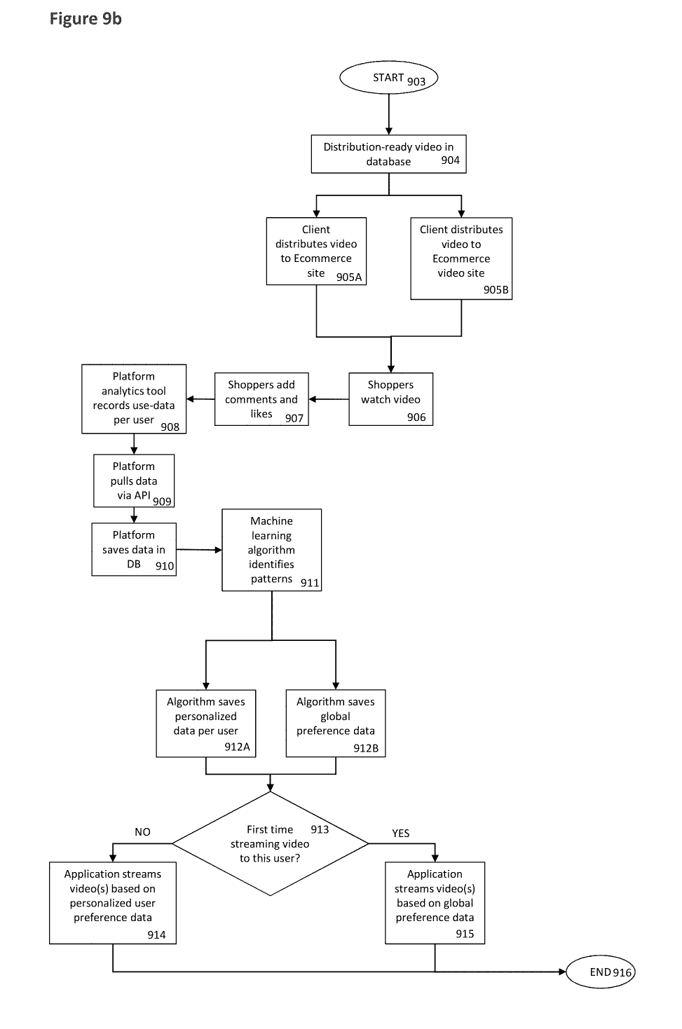

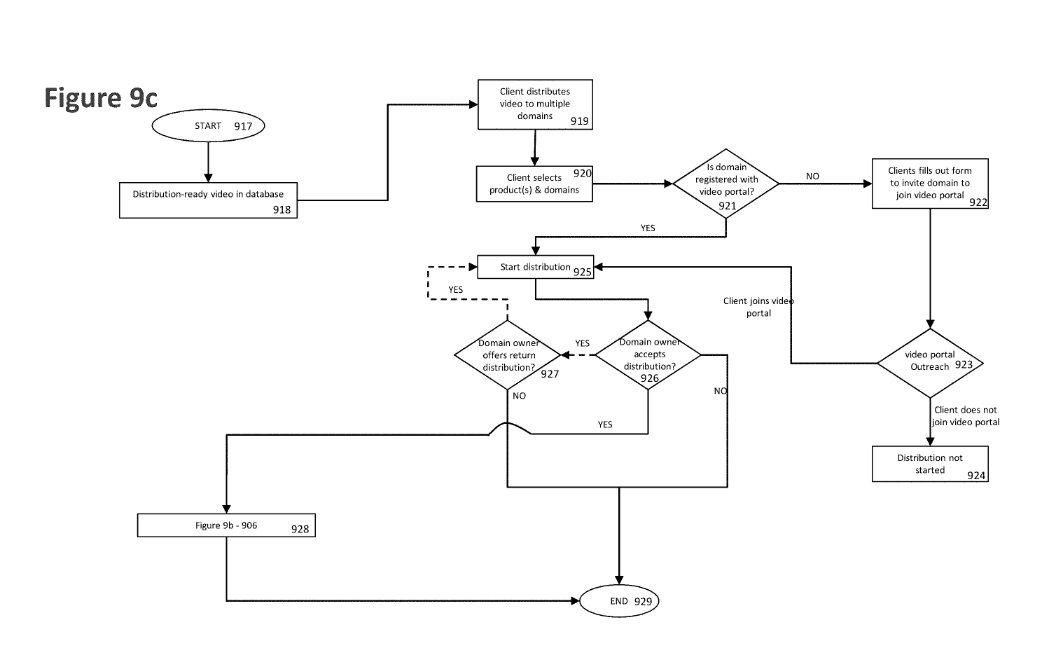

FIG. 9a relates to a non-limiting, exemplary method for video distribution. As shown, video is distributed from the ecommerce video-management platform in 901. The video is optionally distributed to ad networks 902a, OTT networks 902b, social media networks 902c, client partner sites 902d, client site 902e, third-party mobile apps 902f or shopping bots 902g.

FIG. 9b is a non-limiting, exemplary method for distribution of video to an aggregate ecommerce-video platform. As shown in Stage 903, the process begins with distribution-ready video in the database in Stage 904. The client-user may optionally distribute video to the ecommerce site in 905a, but also optionally, preferably distribute it to an aggregate ecommerce-video site in 905b. Shopper-users watch the video in 906. They may optionally add comments and likes in 907. The platform analytics tools records use-data per user in 908. In particular, it records use-data with regard to that specific ecommerce platform, but optionally also benchmarks it against aggregate global-use data across multiple ecommerce sites, networks and on the aggregate ecommerce-video site. The platform then pulls the data from the API in 909 and saves the data to the database in 910. The machine-learning algorithm optionally identifies use-patterns in 911. The algorithm can save personalized data per-user in 912a and can also save aggregate global preference data in 912b. In Stage 913, it's determined whether the platform is streaming video to this user for the first time. If not, then the application streams this video based on pre-recorded personalized user-preference data in 914, and the process ends in 916. If yes, then the application streams video based on aggregate global-preference data in 915. The process ends in 916.

FIG. 9c relates to a non-limiting, exemplary method for distribution syndication. As shown, the process starts in 917 with the distribution-ready video from the database in 918. The client-user distributes the video to multiple domains in 919. The client-user selects the product and domains for distribution in 920. It is determined whether the domain is registered with the platform in 921. If not, then the client-user fills out a form to invite the domain to register on the platform.

Then, the platform performs outreach via email to the domain to offer platform registration in 923. If the second client does not chose to register on the platform, then distribution is not started in 924. If the domain is registered with the platform, 921, then distribution starts in 925. Distribution also starts in 925 if the new client, that is the one with the domain that does not yet belong, decides to register on the platform.

From 925, it is determined whether the domain owner accepts the distribution, that is to say, whether they accept the particular product video stream being distributed or optionally whether they choose to globally accept videos being distributed from their partner in 926. If yes, then the domain may offer return distribution in 927. And then the process, in any case, would move to 928 to FIG. 9b, in particular Stages 906 and the following stages. If the domain owner offers return distribution and is accepted, then new distribution will start in 925, and if not, the process ends in 929. Also, the process optionally ends in 929 if the domain owner does not accept the particular distribution in 926.

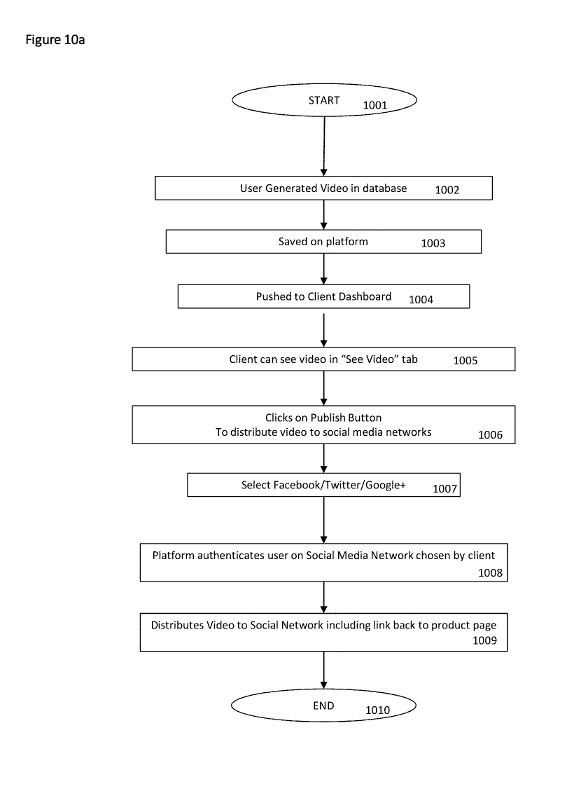

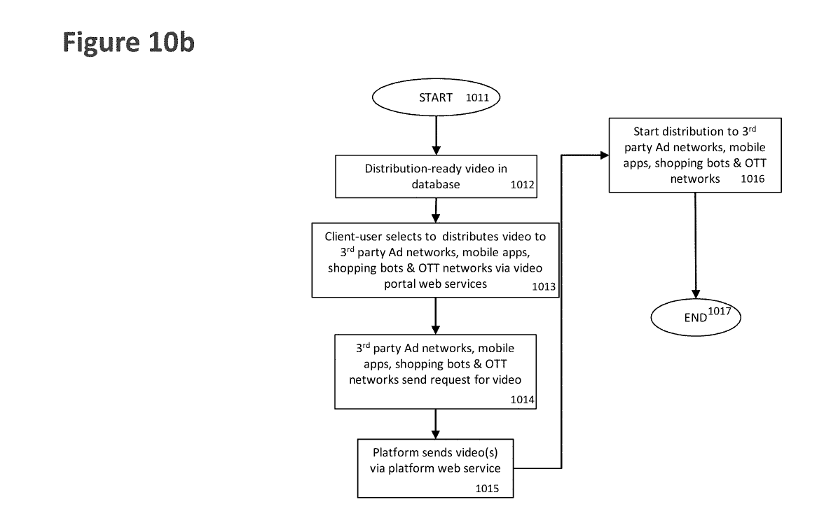

FIG. 10a shows a non-limiting, exemplary method for client-user social publishing. As shown in Stage 1001, user-generated video is prepared for the database in 1002. It is saved on the platform in 1003, and is then pushed to the client dashboard in 1004. The client sees the video in See Video tab in 1005. The client-user can then click on the Publish button to distribute video to social media networks in 1006, optionally, for example, selecting Facebook, Twitter, Google+, other platforms in Stage 1007. The platform authenticates the client on the social media network chosen by the client in 1008 and distributes video to the social network in 1009 along with a link back to the product page on the client ecommerce site to facilitate easy purchase of that product. The process then ends in 1010.

FIG. 10b shows a non-limiting, exemplary method for distribution through ad networks, mobile apps, shopping bots and OTT networks. As shown, the process begins in 1011. The video is distribution-ready from the database in 1012. The client-user selects the video for distribution to third-party ad networks, mobile apps, shopping bots and OTT networks through the platform web services in 1013. The third-party ad networks, mobile apps, OTT networks and shopping bots send the requests to the platform for the video in 1014.

Each of these destinations optionally sends requests for videos based on criteria they gather e.g. product information, retailer et cetera.

Next, the platform sends the video through the platform web services in 1015 and distribution is started to the third-party ad networks, mobile apps, OTT networks and shopping bots in 1016, and the process ends in 1017.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for providing user generated video reviews to a website, an ecommerce website, app or digital network, comprising a user computational device for operating a user interface, such that said user interface receives the video; a server, comprising a video uploader for receiving a user generated video review from said user interface, a moderator module for moderating the uploaded video, and a formatter for formatting the video; and a review computational device, comprising a dashboard for managing the uploaded video and a connector for connecting to the website, ecommerce website, review website, app or digital network; wherein if the uploaded video is accepted by said moderator module, the uploaded video is then formatted by said formatter, and posted to the website, ecommerce website, review website, app or digital network, through said connector.

2. The system of claim 1, wherein said server further comprises a video retriever for retrieving a product related video from a third party site for moderation and formatting.

3. The system of claim 2, wherein said third party site comprises a social media channel.

4. The system of claim 2, wherein said third party site comprises a partner site or distribution network, and wherein videos are exchanged between partners or members of the distribution network.

5. The system of claim 1, wherein said video review comprises a product related video.

6. The system of claim 5, wherein said product related video comprises one or more of social videos, client employee videos and video reviews of features of a specific product.

7. The system of claim 1, wherein said formatter formats said videos for optimal display and transmission before being posted to the website, ecommerce website, review website app or digital network.

8. The system of claim 7, wherein said formatter formats said videos for optimal display on multiple domains and networks.

9. The system of claim 1, wherein said server further comprises a viewing user preference analyzer for analyzing one or more preferences of a viewing user, for selecting one or more videos available on the reviewer site according to said preferences and for displaying said one or more videos through the reviewer site.

10. The system of claim 9, wherein past behavior determines which video(s) are likely to be relevant by said viewing user preference analyzer.

11. The system of claim 10, wherein said past behavior is analyzed from past behavior of the viewing user, the global viewing population and/or a demographically relevant population.

12. The system of claim 11, wherein said past behavior relates to previous videos watched or liked, and/or previous products purchased.

13. The system of claim 1, wherein said reviewer website is selected from the group consisting of an ecommerce website, an influencer website, an ambassador reviewer website, a digital retail network and an expert reviewer website.

14. A method for providing user generated video reviews to a reviewer website, app or digital network, the steps of the method being performed by a computational device, comprising uploading a user generated video review through a user computational device; receiving a user generated video review from said user computational device by a server, moderating the uploaded video and formatting the video; managing the uploaded video to determine whether display is to occur on the reviewer website; accepting the video after moderation, formatting the video, and posting the video to the website, ecommerce website, reviewer website, app or digital network.

15. The method of claim 14, further comprising performing the functions of the system of claim 1.

16. The method of claim 13, wherein said reviewer website is selected from the group consisting of an ecommerce website, an influencer website, an ambassador reviewer website, a digital retail network and an expert reviewer website.
